(19) United States
(12) Patent Application Publication
(10) Pub. No.: US 2008/0156726 A1
(43) Pub. Date: Jul. 3, 2008

(54) Integrating recycle stream ammonia treatment with biological nutrient removal

(76) Inventor: Alexander G. Fassbender, Marlborough, MA (US)

Correspondence Address: Kyla D. Aycock;SPEED LAW FIRM, Suite 1200, 111 Center Street, Little Rock, AR, 72201, US

(21) Appl. No.: 12/074,577

(22) Filed: Mar. 5, 2008

Related U.S. Application Data
(63) Continuation-in-part of application No. 11/517,217, filed on Sep. 6, 2006.
Application No. 11/517,217 is a continuation-in-part of application No. 11/517,111, filed on Sep. 6, 2006.
(60) Provisional application No. 60/959,213, filed on Jul. 12, 2007.

(51) Int. Cl. C02F 3/28; B01D 35/18

(52) U.S. Cl. 210/613; 210/180; 210/188

(57) ABSTRACT

Embodiments include a method and apparatus for recovering ammonia and nitrogen from a waste stream. Embodiments further include recovering ammonia using an ammonia recovery process and a biological nitrogen recovery process. In some embodiments, a return stream from the ammonia recovery process may be used to provide alkalinity, carbon substrate, and/or biological oxygen demand to the biological nitrogen recovery process. In some embodiments, a hydrothermal sludge process may be used to further treat the waste stream and provide additional return to the ammonia recovery system. Other embodiments include an ammonia recovery system for conducting the ammonia recovery process, a biological nitrification and/or denitrification system for conducting the biological nitrogen recovery process, and an optional hydrothermal sludge processing system.

### CROSS-REFERENCE TO RELATED APPLICATIONS

This application claims benefit of U.S. Provisional Patent Application Ser. No. 60/959,213, filed Jul. 12, 2007, which is herein incorporated by reference in its entirety. Further, this application is a continuation-in-part of co-pending U.S. Patent Application Ser. No. 11/517,217, filed Sep. 6, 2006 and entitled “Nutrient Recovery Process,” and is also a continuation-in-part of co-pending U.S. patent application Ser. No. 11/517,111, filed Sep. 6, 2006 and entitled “Ammonia Recovery Process,” both applications having the inventor Alexander G. Fassbender. Each of the aforementioned related patent applications is herein incorporated by reference in its entirety.

### BACKGROUND OF THE INVENTION

1. Field of the Invention

Embodiments of the present invention generally relate to an ammonia recovery process. More particularly, embodiments relate to a process for recovering ammonia and other nutrients from waste streams.

2. Description of the Related Art

Waste streams contain several components which it is desirable to separate from the waste streams and from one another, either for recovery of the components for later use or to prevent release of the components or combinations of the components to the environment. These waste streams may result from anaerobic digestion of sewage or animal wastes, from industrial processes such as rendering operations, from coke and chemical manufacture, and from food and agricultural processes.

Some of the components which are useful to separate from the waste stream are phosphorous, potassium, alkali earth metals, and ammonia. In particular, it is useful to separate nitrogen and ammonia from the waste stream.

Nitrogen exists in the environment in several unoxidized forms and oxidized forms. Unoxidized forms of nitrogen include nitrogen gas (N₂), ammonia (NH₄⁺ and NH₃), and organic nitrogen such as urea, amino acids, peptides, proteins, etc. Ammonia exists in the form of ammonia (NH₃), which is toxic to fish, and ammonium (NH₄⁺), which is not toxic to fish. Oxidized forms of nitrogen include nitrite (NO₂⁻), nitrate (NO₃⁻), nitrous oxide (N₂O), nitric oxide (NO), and nitrogen dioxide (NO₂).

Anaerobically digested sewage sludge and animal wastes may be separated into a solids-rich stream and a solids-depleted stream, where the solids-depleted stream contains the bulk of the water as well as a variety of chemicals dissolved and suspended in the water. The suspended chemicals in the solids-depleted stream typically include ammonia nitrogen (NH₃-N) having a typical concentration ranging from 600 parts per million (ppm) to 8,000 ppm, hardness in the form of calcium carbonate with a typical concentration ranging from 50 ppm to 350 ppm, phosphate having a typical range of concentration from 2 ppm to 150 ppm, and total suspended solids having a typical concentration range of 500 ppm to 2,000 ppm. Ammonia may be removed from the solids-depleted stream.

To remove nitrogen from the waste stream, the main waste treatment process may include a biological nitrogen removal (“BNR”) system and process. The BNR system and process may include nitrification and denitrification of the waste stream to remove nitrogen therefrom.

During the nitrification part of the BNR process, alkalinity is continually lost and therefore must be supplemented by adding alkalinity to the BNR process to allow proper BNR. Additionally, with the current trend toward water conservation and minimizing storm water influent, the concentration or strength of sewage is increasing, leading to higher nitrogen loads and insufficient alkalinity in the nitrification stage in particular. To accomplish nitrification, external alkalinity must often be added to the BNR process especially in these higher nitrogen load waste streams.

Furthermore, during the BNR process, an organic or carbon source such as methanol is required to achieve denitrification. Denitrification rate changes with the source of available carbon, and highest denitrification rates are achieved with the addition of the carbon source. Thus, the addition of the carbon source to the BNR process and system is often necessary to accomplish denitrification, which adds expense to the BNR process and system in operational and capital costs. Current methanol costs may range from $0.70/gallon to $3.00/gallon. Methanol is flammable, and storage requirements such as National Fire Protection Agency Requirements are stringent and costly to implement and maintain.

Adding external alkalinity and an external carbon source to the BNR process and system requires high chemical and energy consumption, causing higher operational costs, and a larger sized waste treatment plant, causing increased capital costs. Furthermore, adding external alkalinity and an external carbon source to the BNR process and system increases the size and footprint of the waste treatment plant, increases the consumption of chemicals and energy by the waste treatment plant, and increases carbon dioxide emissions, thereby negatively impacting the environment.

Therefore, there is a need for a nitrogen and ammonia recovery process and system which decreases operational costs of the waste treatment plant while remaining effective in nitrogen and ammonia recovery from the waste stream.

There is a further need for a nitrogen and ammonia recovery process and system which decreases capital costs of the waste treatment plant while remaining effective in nitrogen and ammonia recovery from the waste stream.

Additionally, there is a need for a nitrogen and ammonia recovery process and system which decreases negative environmental impact of the waste treatment plant and process.

There is yet a further need for a process and system which decreases or eliminates the need to add external alkalinity and carbon substrate to a BNR process and system to achieve nitrification and/or denitrification.

### SUMMARY OF THE INVENTION

To this end, embodiments advantageously provide a nitrogen and ammonia recovery process and system which decreases operational costs of the waste treatment plant while remaining effective in nitrogen and ammonia recovery from the waste stream.

Embodiments also advantageously provide a nitrogen and ammonia recovery process and system which decreases capital costs of the waste treatment plant while remaining effective in nitrogen and ammonia recovery from the waste stream.

Embodiments further provide a nitrogen and ammonia recovery process and system which decreases negative environmental impact of the waste treatment plant and process.

Further embodiments provide a process and system which decreases or eliminates the need to add external alkalinity and carbon substrate to a BNR process and system to achieve nitrification and/or denitrification.

Embodiments generally include a method of removing ammonia from a stream, comprising separating a nitrogen containing stream into a first solids-depleted stream and a first solids-rich stream; treating the first solids-rich stream with anaerobic digestion to produce an ammonium containing treated solids-rich stream; separating the treated solids-rich stream into a second solids-rich stream and an ammonium containing second solids-depleted stream; using an ammonia recovery process for removing the ammonia from the second solids-depleted stream, comprising adding a sufficient amount of one or more bases to the second solids-depleted stream to convert the ammonium to ammonia and the bicarbonate to carbonate, and transforming the ammonia into the vapor phase and subsequently collecting the ammonia in a liquid stream using one or more vapor removal devices, thereby separating the liquid ammonia stream from a return stream; conducting a biological process to remove ammonia from the first solids-depleted stream, the biological process comprising a nitrification process; and flowing the return stream into the biological process. Further embodiments include a method of removing ammonia from a stream, comprising separating a nitrogen containing stream into a first solids-depleted stream and a first solids-rich stream; treating the first solids-rich stream with a hydrothermal process to produce an ammonium containing treated solids-rich stream; separating the treated solids-rich stream into a second solids-rich stream and an ammonium containing second solids-depleted stream; using an ammonia recovery process for removing the ammonia from the second solids-depleted stream, comprising adding a sufficient amount of one or more bases to the second solids-depleted stream to convert the ammonium to ammonia and the bicarbonate to carbonate, and transforming the ammonia into the vapor phase and subsequently collecting the ammonia in a liquid stream using one or more vapor removal devices, thereby separating the liquid ammonia stream from a return stream; conducting a biological process to remove ammonia from the first solids-depleted stream, the biological process comprising a nitrification process; and flowing the return stream into the biological process.

Embodiments further include an apparatus for removing ammonia from a waste stream, comprising one or more separating devices for separating an anaerobically digested waste stream into a solids-rich stream and a solids-depleted stream; an ammonia recovery system for recovering ammonia from the solids-depleted stream, comprising a base source for adding one or more bases to the solids-depleted stream, and one or more vapor removal devices for transforming ammonia in the solids-depleted stream into the vapor phase and subsequently collecting the ammonia in a liquid stream, thereby forming the ammonia liquid stream and a return stream; and a biological ammonia removal system to remove ammonia from the solids-depleted stream, the biological ammonia removal system comprising a nitrification system, wherein the return stream is flowable through a return pathway from the ammonia recovery system to the biological ammonia removal system.

### DESCRIPTION OF THE DRAWINGS

So that the manner in which the above-recited features of embodiments of the present invention can be understood in detail, a more particular description of the invention, briefly summarized above, may had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a process flow diagram of an example biological nitrogen removal process.

FIG. 2 is a table showing expected operational cost savings available in BNR scenarios with an ammonia recovery process and system.

FIG. 3 is a process flow diagram of a first embodiment of an ammonia recovery process and system.

FIG. 4 is a process flow diagram of a second embodiment of an ammonia recovery process and system.

FIG. 5 is a process flow diagram of an example single-sludge BNR process and system.

FIG. 6 is a table showing example results of operation of the single-sludge process and system of FIG. 5.

FIG. 7 is a graph of plant nitrogen profile showing concentration of ammonia nitrogen and nitrate nitrogen in example results of operation of the process and system of FIG. 5.

FIG. 8 is a graph showing effluent ammonia nitrogen and nitrate nitrogen response including concentration versus time.

FIG. 9 is a process flow diagram of an example two-sludge BNR process and system.

FIG. 10 is a table showing example results of operation of the two-sludge BNR process and system of FIG. 9.

FIG. 11 shows parameters used to obtain the results shown in the tables of FIGS. 6 and 10.

FIG. 12 is a table summarizing results of a sensitivity analysis of the single-sludge BNR process and system depicted in FIG. 5.

FIG. 13 is a table summarizing results of a two-sludge sensitivity analysis of the two-sludge BNR process and system depicted in FIG. 9.

### DETAILED DESCRIPTION

U.S. Pat. No. 6,893,566 entitled “Sewage Treatment System,” filed on Feb. 26, 2003 and issued on May 17, 2005, is incorporated by reference herein in its entirety. Also incorporated by reference herein in its entirety is U.S. Pat. No. 7,270,796 entitled “Ammonium/Ammonia Removal from a Stream” having the inventors Kemp et al. and filed on Aug. 11, 2005 and issued on Sep. 18, 2007.

Embodiments apply to waste stream treatment applications, for example wastewater treatment applications, where there is either an ammonia containing internal recycle stream and/or an externally supplied stream. More specifically, embodiments apply to waste stream treatment systems, for example wastewater treatment systems, where anaerobically digested sludge is dewatered into a high-solids stream and a low-solids stream wherein there is an appreciable concentration of ammonium ion dissolved in the low-solids stream (centrate). In addition, embodiments relate to a waste stream (e.g., wastewater) treatment plant or system where some form of biological nutrient (nitrogen) removal (“BNR”) is present. Most specifically, this invention may apply to a wastewater treatment system such as the Blue Plains plant near Washington, D.C. where the nitrogen discharge limits are stringent, and where the plant uses one or more anaerobic digesters and produces centrate from digested sludge dewatering operations.

An element of embodiments is using an ammonia recovery process (“ARP”) and ammonia recovery system (“ARS”) to recover ammonia from the centrate or other high ammonia stream. The term ARP may refer to a process which may include any or all of the following: pre-treatment, roughing operation, and a polishing operation. The term ARS may refer to devices, components, and/or arrangements for accomplishing any or all of the aforementioned ARP. High ammonia streams may be reduced to approximately 100-300 ppm during the roughing operation by using one or more bases such as caustic to convert the ammonium ion to ammonia and then removing the ammonia via a suitable liquid-vapor separations system such as steam or air stripping or vacuum distillation. In the case of centrate from anaerobically digested sludge, the ammonium cation is typically paired with a bicarbonate anion. In the process of raising the pH of the centrate stream and converting ammonium ions to ammonia using the one or more bases such as caustic, the bicarbonate anions are converted into carbonate anions. Carbonate anions are highly basic and may be used to provide alkalinity to waste stream (wastewater) treatment plant operations such as BNR.

An applicable example chemical reaction of an ARP is as follows:

2NaOH+NH₄⁺+HCO₃⁻=>NH₃+2Na⁺+CO₃⁻²+2H₂O

In the example biological nitrification reactions described below, acid, H+, is produced when ammonium ion is oxidized into nitrous acid. The carbonate and bicarbonate anions react with acid in the following manner.

H⁺+CO₃⁻² [symbol] HCO₃⁻

H⁺+HCO₃⁻ [symbol] CO_{2(gas)}+H₂O

Embodiments include using the basic nature or ‘alkalinity’ of the carbonate anions remaining after the ARP including liquid-vapor removal of ammonia from the high pH centrate (which may include a pH of approximately 9 to approximately 12) to balance the alkalinity loss of the main plant BNR process. Methods and processes for an ARP removing ammonia from the centrate are described by Kemp et al. and Fassbender's patent applications which were incorporated by reference herein above. Any of these ARPs may be utilized in connection with embodiments. Embodiments specifically relate to the use of the high pH stream obtained during ammonia separation to enhance alkalinity for the biological nitrification process of a waste stream (wastewater) treatment plant and system. A corresponding benefit of capturing the ammonia in this way is that it simultaneously reduces the load on the BNR portion of the plant by the amount of ammonia recovered. A further benefit is that less chemicals and energy are consumed. A further benefit is that the captured ammonia is available for sale and beneficial reuse. A further benefit is that use of the subject invention allows fewer emissions of carbon dioxide, a greenhouse gas. A further benefit is that the size of the waste water treatment plant may be reduced. A further benefit is that less waste sludge is produced. A further benefit is that the waste stream treatment plant may be able to process other high ammonia streams in addition to streams it generates internally.

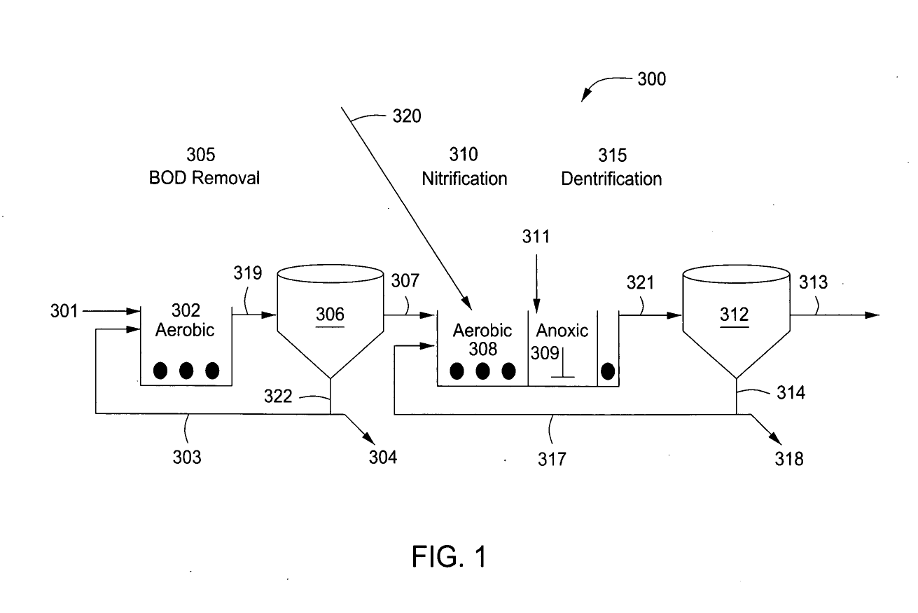

FIG. 1 shows an embodiment of an example BNR process and system 300 including biological oxygen demand (“BOD”) removal in a BOD removal zone 305, nitrification in a nitrification zone 310, and denitrification in a denitrification zone 315. The BNR process and system of FIG. 1 is based on the design of the Blue Plains plant and is a two-stage nitrogen removal process post denitrification. This BNR system and process 300 shown in FIG. 1 may be a once-through plant without recovery of denitrification alkalinity where an anoxic zone follows an aerobic zone in the second stage of the Blue Plains plant.

In the embodiment shown in FIG. 1, primary effluent 301 enters an aerobic environment, for example an aerobic environment established in BOD tank 302. A first stream 319 exits the aerobic environment and may feed into a clarifier 306, where a clarified stream 307 is split from a sludge stream 322 (which may be a microbial biomass stream). The sludge stream 322 is then split into a first waste sludge stream 304 (which may be a first waste biomass stream) and a recycled sludge stream 303 (which may be a recycled biomass stream). The recycled sludge stream 303 (or microbial biomass stream) is recycled back into the BOD tank 302.

The clarified stream 307 may be fed into the nitrification tank 308, which is preferably an aerobic zone to effect nitrification. A high alkalinity, high pH, and low ammonia centrate stream 320 generated from an ammonia recovery process and system based on raising pH and vapor removal of ammonia is fed into the BNR process system 300 preferably at or prior to the nitrification zone 310, for example into one or more nitrification tanks 308. This stream 320 may possess a high alkalinity of from approximately 500 parts per million (“ppm”) to approximately 20,000 ppm, a high pH of from approximately 9 to approximately 12, and a low ammonia concentration of from zero to approximately 300. The alkalinity requirement of the nitrification is thus either fulfilled or reduced by the addition of the centrate stream 320 from the ammonia recovery process and system to the nitrification process. Nitrification ensues based upon the nitrification reactions disclosed herein.

After nitrification treatment in the nitrification zone 310, the centrate flows into one or more denitrification tanks 309, which is preferably an anoxic zone to effect denitrification. If desired or needed, methanol or another carbon-containing substrate may be added to the denitrification tank 309 via organic substrate stream 311 to aid in the denitrification.

The product stream 321 from the nitrification/denitrification may exit the denitrification tank 309 and may enter a settling tank 312 which separates an effluent stream 313 from a sludge stream 314. The effluent stream 313 exits the BNR system 300 and may be further treated, stored, used, or otherwise disposed of. The sludge stream 314 may be split into a nitrogen containing biomass waste sludge stream 318 and a biomass recycle sludge stream 317. The recycle sludge stream (or recycle biomass stream) may be recycled into the nitrification zone 310 through the nitrification tank 308 for further processing.

In general, the oxidation of ammonia in the waste stream treatment plant's main flow BNR system and process may require approximately 7.14 mg/l of alkalinity for every 1 mg/l of ammonia oxidized. In two-stage or three-stage BNR processes, there may be a requirement for sufficient alkalinity to maintain approximately 50 mg/l of alkalinity as CaCO₃ in solution. This needed alkalinity is typically not available within the waste stream treatment system, requiring alkalinity to be added to the system. Following are example nitrification reactions and example alkalinity requirements for nitrification (all numerical values are approximate):

Nitrification:

Nitrosomonas: (rate limiting step)

2NH₄⁺ + 3O₂ [symbol] 2NO₂⁻ + 2H₂O + 4H⁺
Oxygen Required = 3.43 lb/lb N oxidized
Alkalinity Required = 7.14 lb as CaCO3/lb N oxidized

Nitrobacter:

2NO₂⁻ + O₂ [symbol] 2NO₃⁻
Oxygen Required = 1.14 lb/lb N oxidized

For both reactions together:
Total Oxygen Requirement = 4.57 lbs/lb N oxidized
Total Alkalinity Requirement = 7.14 lbs as CaCO₃/lb N oxidized

Some alkalinity is generated in the denitrification or conversion of nitrate and methanol into bicarbonate, nitrogen, water, and hydroxyl anion. An example denitrification reaction is as follows:

### Denitrification:

6NO₃⁻+5CH₃OH [symbol] 5HCO₃⁻+3N_{2(gas)}+7H₂O+OH⁻

Methanol Utilized=1.9 lbs methanol per lb nitrate-N denitrified

This is equivalent to 2.86 lbs chemical oxygen demand (“COD”) utilized per lb nitrate-N denitrified (Note:

Actual methanol dose required=2.5 to 3.0 lbs methanol per lb nitrate-N denitrified).

Alkalinity produced=3.57 lbs as CaCO₃ per lb nitrate-N denitrified

Dissolved oxygen (“DO”) inhibits denitrification. As DO increases, denitrification rate decreases. In general, DO should be maintained below approximately 0.3 mg/L in an anoxic zone to achieve denitrification. As temperature increases, denitrifier growth rate increases. Denitrifiers are generally less sensitive to pH than nitrifiers. If the pH is within the recommended range for nitrification, no pH effects on denitrification occur.

There are at least two approaches to managing alkalinity during the nitrification step of a BNR process. In one approach the alkalinity of the denitrification process is used in nitrification and in the other approach it is not. In the case where alkalinity produced from the denitrification is used in the nitrification, it is assumed in an example that the starting alkalinity of the influent waste stream is the set point for the process. In the case where the denitrification alkalinity is not used and alkalinity, typically in the form of caustic, is used, a value of 50 ppm is set based on standard industry practice and guidance.

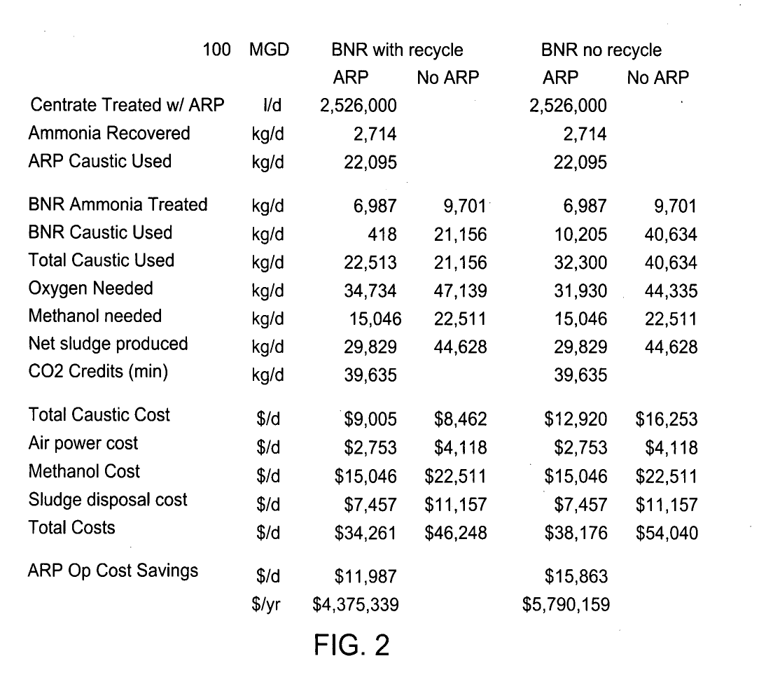

The table shown in FIG. 2 presents a summary of the expected operational cost savings available in both BNR scenarios (BNR with denitrification alkalinity recycled and without denitrification alkalinity recycled). In both scenarios, the centrate may be processed with the roughing device only. Depending on the hardness and design requirements, a water softening step may optionally be placed in front of the roughing step. The ammonia recovery process (“ARP”) may include the following, for example, as shown and described in the “Ammonia Recovery Process” patent application incorporated by reference herein. Caustic and/or another base may be added to a waste stream to raise the pH to the desired level, thereby converting the ammonium to ammonia and the bicarbonate to carbonate. The ammonia may be removed using one or more liquid-vapor separation devices that move the ammonia into the vapor phase and then collect it in a subsequent separate liquid stream. This liquid-vapor separation device may be a steam, air, or vacuum stripper. The high-pH liquid remaining after the removal of ammonia via the ARP may be reused to provide alkalinity in the nitrification step in the waste stream treatment plant.

For example, the centrate may be treated by using caustic and/or another base to shift the pH from a value of approximately 6 to approximately 8 to a pH value of approximately 10 to approximately 12, converting the ammonium to ammonia and the bicarbonate to carbonate. The bulk of the ammonia may be removed in one or more liquid-vapor separation devices such as one or more separation devices (e.g., vacuum scrubbers and/or rCAST devices). The treated centrate stream is depleted in ammonia (may include from 0 to approximately 300 ppm ammonia) and enriched in hydroxyl (may possess a pH of from approximately 9 to approximately 12) and carbonate anions (may include from approximately 500 ppm to approximately 20,000 ppm carbonate anions). This high-pH (preferably a pH of approximately 9 to approximately 12) and low ammonia treated stream may then be added to the nitrification section of a BNR operation to increase the alkalinity of the nitrification portion of the BNR section of the waste stream treatment plant. In this manner, the portion of the caustic and/or other base used to convert the bicarbonate anion into carbonate anion may be fully recovered. The ammonia removed is no longer part of the BNR load, thereby reducing the amount of bases such as caustic that the BNR system and process would require during the nitrification reactions as well as the methanol or other carbon source needed for the subsequent denitrification process. This reduction in load and this reuse of the ARP treated stream decrease the overall operating cost for the BNR unit and process and significantly decrease its size because the load is reduced. The cost savings associated with the size reduction may be comparable to or greater than the cost of implementing embodiments. Furthermore, the production of additional sludge as well as carbon dioxide is advantageously reduced by the embodiments.

The use of this technique need not be constrained to streams generated wholly within the wastewater treatment plant. Embodiments may be employed to deal with high ammonia streams brought to the waste stream treatment plant by industrial facilities or land fill operators, for example. The high ammonia stream could be treated in manners described herein and the resultant low ammonia, high pH stream used in a similar manner to mitigate the alkalinity consumption of the BNR nitrification reactions.

FIG. 2 represents results based on a preliminary model for the two cases of BNR with recovery of denitrification alkalinity (entitled “BNR with recycle”) and of BNR without recovery of denitification alkalinity (entitled “BNR no recycle”).

Some embodiments include a combined Ammonia Recovery Process (ARP) and BNR system. The capital and operating costs of such a system may be less than the capital and operating costs of a BNR system alone. As mentioned above, embodiments advantageously possess a smaller energy and greenhouse gas footprint as well as requiring a smaller real estate footprint. Additionally, embodiments allow the beneficial reuse of the produced ammonium sulfate and the ability to operate the secondary treatment at a low DO and solids retention time (“SRT”) for maximum bacterial growth and nitrogen uptake.

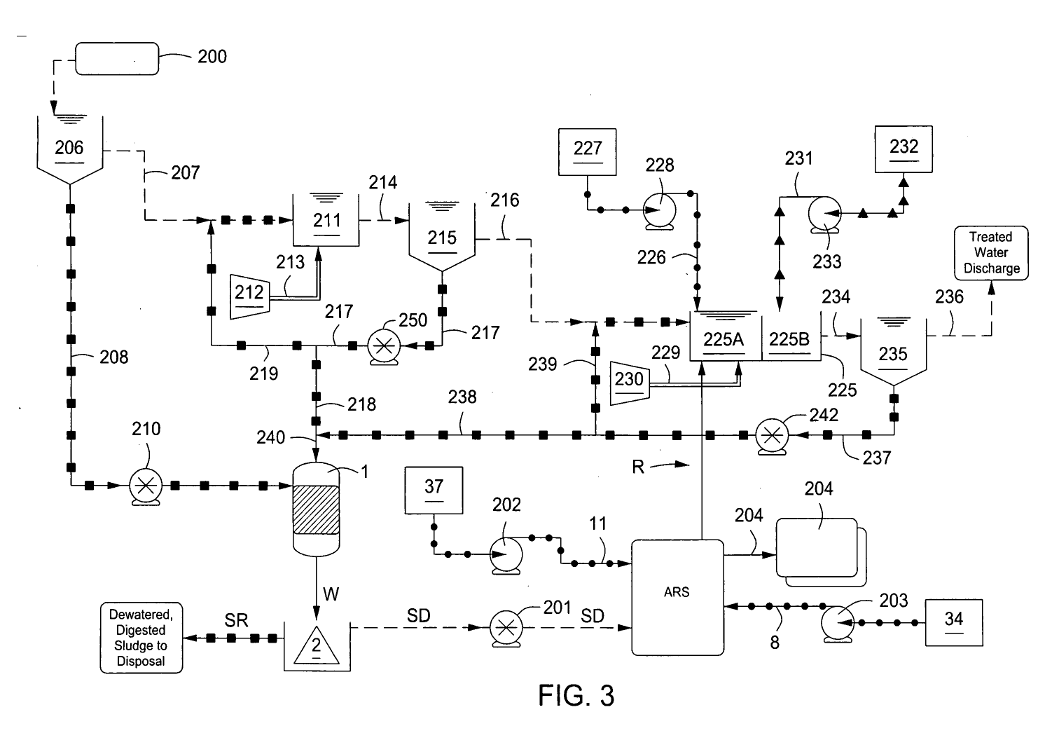

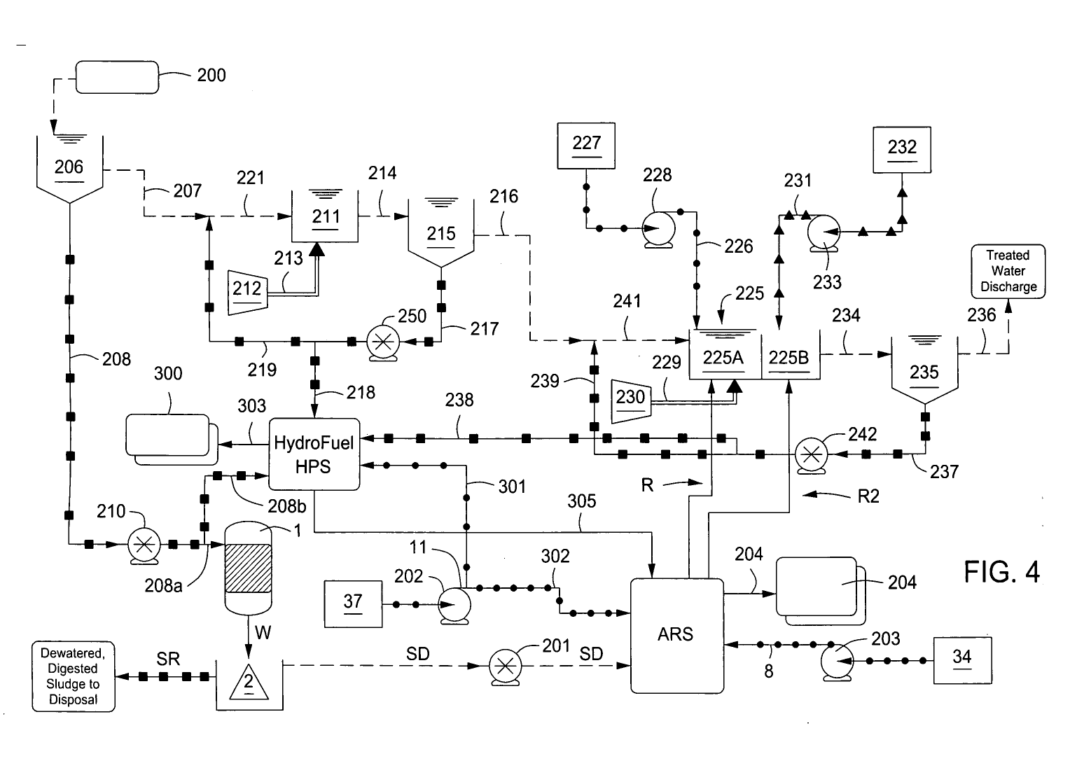

The numbers shown in FIG. 2 may be conservative, and it is suspected that the actual savings will be greater than these numbers for two reasons. First, technical papers suggest a value of 3.15 masses of methanol (MeOH) per mass of NO₃ N rather than the conservative 2.75 number used in the FIG. 2 calculations. Second, the model numbers do not account for the denitrification sludge nitrogen in stream 318 in FIG. 1 that is recycled through the digester and thereby makes more ammonia-laden centrate. Essentially, the methanol (or other carbon substrate) produces micro-organisms. The yield of micro-organisms is about 0.40 times the COD of the methanol. These excess micro-organisms generate additional sludge in the one or more clarifiers or separators (see explanation of FIGS. 3 and 4 below), and this sludge generates more ammonia and centrate after it is digested, which is a non-trivial effect of about 9% to about 12%. Thus, the actual difference between BNR with no ARP will likely be greater than the estimate shown in FIG. 2. In addition, ARP may be implemented immediately during an upgrade of a Water Pollution Control Plant (WPCP) and take load off the waste stream treatment plant while the major BNR modifications are made to implement embodiments, helping to ensure minimum impact on plant performance during the upgrade.

Embodiments include using the alkalinity remaining after liquid-vapor removal of ammonia from a centrate stream to balance the alkalinity loss of the main plant BNR process. The oxidation of ammonia in the waste treatment plant's main flow BNR system requires a significant amount of alkalinity. There are two approaches to returning alkalinity obtained or added during the treatment of the centrate back to the BNR section of the main plant. Each of these approaches constitutes a separate embodiment. The first approach is one where the centrate is processed with the roughing device only. In this case, caustic or lime is added to raise the pH to the desired level to convert the ammonium to ammonia and the bicarbonate to carbonate. The ammonia is then removed using a device that moves the ammonia into the vapor phase and then collects it in a subsequent low-pH liquid-containing device such as a scrubber. For instance, the centrate may be treated by using lime or caustic to shift the pH and the ammonia removed in an rCAST device. The resultant stream would be depleted in ammonia and enriched in hydroxyl and possibly carbonate anions. Then the high-pH treated stream may be utilized to reduce the alkalinity requirement of the BNR portion of the waste stream treatment plant.

Useful and valuable quantities of ammonia and nitrogen are recovered from a waste stream using various processes and equipment. FIGS. 3 and 4 show embodiments of the ammonia and nitrogen recovery process and system.

As shown in FIGS. 3 and 4, the influent waste stream 200, which may include for example sewage sludge or animal wastes (but may also include waste resulting from industrial processes such as rendering operations or food or agricultural processes, or from coke or chemical manufacture), is optionally treated with one or more primary clarifiers 206 or other separating devices. Exiting from the one or more primary clarifiers 206 are a first primary clarified stream 207 and a second primary stream 208 containing sludge. The first primary clarified stream 207 may enter the main plant BNR process and system described herein, while the second primary sludge stream 208, after some preparation described below, produces a wastewater that may enter an ammonia recovery system ARS, for example an ARS based on raising pH and vapor removal of ammonia.

The second primary sludge stream 208 may be anaerobically digested by one or more anaerobic digesters 1 to produce a digested waste stream W. An optional pump 210 may be included to pump the sludge stream 208 into the anaerobic digester 1. This digested waste stream W typically has a substantially neutral pH value (a pH of approximately 7).

The digested sludge W is then separated into a solids-rich stream SR and a solids-depleted stream SD (also referred to as “centrate” or “filtrate”). The digested sludge W may be separated into these streams SD and SR by one or more separating devices 2, which may include one or more of any separating or filtering devices known to those skilled in the art, including but not limited to one or more centrifuges, filter presses, settling basins, and/or other separation devices.

The solids-depleted stream SD contains the bulk of the water as well as a variety of chemicals dissolved and suspended in the water, the dissolved and suspended chemicals typically including ammonium bicarbonate (NH₄HCO₃), calcium bicarbonate (Ca(HCO₃)₂) as the hardness, phosphate, and suspended solids. Some typical concentration ranges of these chemicals dissolved and suspended in the water are shown in Table 1 below:

TABLE 1

| | Typical Concentration Range (End values | |
|---|---|---|
| Constituent | of ranges are approximate) | |
| ammonia nitrogen | 600-8000 | parts per million (ppm) |
| calcium carbonate | 50-350 | ppm |
| phosphate | 2-150 | ppm |
| total suspended solids | 500-2,000 | ppm |

Of course, the solids-depleted stream SD may contain other chemicals in addition to those listed above, and/or the constituents may be present in the solids-depleted stream SD in different concentrations. The solids-depleted stream SD may be a centrate stream, while the solids rich stream SR may be a bio-solids cake. After separating the solids-depleted stream SD from the solids-rich stream SR, the solids-rich stream SR containing bio-solids, the solids-rich stream SR may be collected in a vessel, further treated, or otherwise disposed or removed from the remainder of the ammonia recovery process.

The solids-depleted stream SD, which contains raw centrate or filtrate from centrifuging or filtering equipment (or other separating equipment), may still contain suspended solids which must be removed prior to ammonia recovery processing. A highly robust approach to removing these suspended solids couples dissolved air flotation with one or more multi-media and/or cartridge filters to achieve a low suspended solids stream. Depending upon the quantity of suspended solids present in the stream and their nature, one or more microfilters may optionally be utilized.

Optionally, a centrate pump 201 is included to increase the pressure of the solids-depleted stream SD. Ammonia is then recovered from solids-depleted stream SD via an ammonia recovery process performed by an ammonia recovery system ARS based on raising the pH of the centrate and vapor removal of ammonia, as shown and described in patent applications incorporated by reference herein such as U.S. patent application Ser. No. 11/517,111, filed Sep. 6, 2006 and entitled “Ammonia Recovery Process.” Generally, embodiments of the ammonia recovery process performed by the ammonia recovery system ARS may include one or more of the following method steps: filtering out suspended solids from the waste stream, softening the centrate, removing the bicarbonate buffer, stripping ammonia to convert the ammonium ion to ammonia and raise the pH of the centrate, and accomplishing absorption of the excess carbon dioxide.

It is within the scope of embodiments that other ammonia recovery systems and processes may be substituted for the ARS and process described in the aforementioned patent application.

Caustic (and/or another comparable base) through a caustic (or other base) stream 11 and sulfuric acid (or another comparable acid) through a sulfuric acid (or other acid) stream 8 may be added to the ammonia recovery system ARS as described in the above-referenced patent application, for example via caustic tank 37 and sulfuric acid tank 34, respectively. Optionally, a caustic pump 202 may be included to pump the caustic stream 11 into the ammonia recovery system ARS, and an acid pump 203 may be included to pump the acid stream 8 into the ammonia recovery system ARS. Now referring to FIG. 3, exiting products from the ammonia recovery system ARS may be an ammonium sulfate stream 204 (when the acid is sulfuric acid) and a low ammonia, high pH, and high alkalinity return stream R, as previously described (e.g., having a pH of from approximately 9 to approximately 12, an ammonia concentration of from approximately 0 ppm to approximately 300 ppm, and an alkalinity concentration of from approximately 500 ppm to approximately 20,000 ppm).

The first primary clarified stream 207 enters the main plant biological nutrient removal BNR system and process. The first primary clarified stream 207 flows into one or more aeration tanks 211. Compressed air 213 (and/or other oxygen-containing compressed gas) may be delivered to the one or more aeration tanks 211, optionally via one or more air (or gas) compressors 212. The stream 214 exiting the one or more aeration tanks 211 may enter one or more secondary clarifiers 215 or other separating devices.

Now still referring to FIG. 3, after processing in the one or more secondary clarifiers 215, a clarified stream 216 continues on to the nitrification/denitrification (BNR) process described below, while a sludge stream 217 (or microbial biomass stream) may be recycled into the aeration tank 211 and/or into a stream 218 which ultimately enters the anaerobic digester 1. The sludge stream 217 may be pressurized by an optional sludge pump 250. When the sludge stream 217 is split between the anaerobic digester 1 and the stream entering the aeration tank 211, the sludge stream 217 is split into a first recycle stream 219 which may optionally flow directly into aeration tank 211 or may combine with the first primary clarified stream 207 into aeration tank feed stream 221 which enters the aeration tank 211, and a second stream 218 which ultimately enters the anaerobic digester 1 after being optionally combined with another sludge stream 238 exiting the nitrification and/or denitrification BNR process, as described below.

The clarified stream 216 is ultimately flowable into a nitrification/denitrification tank 225. In the nitrification/denitrification tank 225, a combination of nitrification and denitrification processes are performed. In one embodiment, nitrification is performed followed by denitrification. Nitrification may be accomplished in one or more nitrification tanks 225A, and denitrification may be accomplished in one or more denitrification tanks 225B. Optionally, caustic (and/or another base) via a caustic stream 226 may be added to the nitrification tank 225A. The caustic stream 226 may optionally be flowed from one or more caustic tanks 227 and pumped by one or more caustic pumps 228. Additionally, compressed air 229 (and/or another oxygen-containing compressed gas) may enter the nitrification tank 225A, for example from one or more air/gas compressors 230.

BNR, including nitrification and denitrification, is employed to remove nitrogen from the waste stream. One or more nitrification processes and systems as well as one or more denitrification processes and systems are encompassed by embodiments. Furthermore, although the preferred order of treatment is nitrification followed by denitrification, it is within the scope of embodiments to perform the treatment in the opposite order. It is also within the scope of embodiments for BNR to include only nitrification without denitrification.

Following is a discussion of a nitrification/denitrification process and system, which is also described in some of the above paragraphs. Two bacterial genera are responsible for nitrification. Nitrosomonas oxidizes ammonia to the intermediate product nitrite and nitrite is converted to nitrate by Nitrobacter. The term nitrifier is a general term that applies to a consortia of Nitrosomonas and Nitrobacter well known in the art. Nitrifying bacteria are present in almost all aerobic biological treatment processes, but their numbers may be limited. There are many aerobic processes that have been developed to favor nitrification, which may be separated into two main groups: suspended-growth and attached-growth. In suspended-growth nitrification, a nitrifying sludge composed of free bacteria is mixed with the wastewater liquid by the aeration or agitation of the liquid. The commonly used activated-sludge process is a suspended growth process that combines bacterial biological oxygen demand (BOD) removal and bacterial nitrification treatment (nitrogen removal) that are performed by separate bacteria. In other cases, carbon oxidation and nitrification functions are done in separate tanks.

The nitrification process entails using nitrifying organisms to oxidize ammonium ions (NH₄⁺) to nitrite (NO₂⁻) and nitrate (NO₃⁻). A nitrification reaction (biological oxidation) is as follows:

NH₄⁺—N(ammonia)+O₂(oxygen)+HCO₃⁻(alkalinity)→Nitrosomonas

NO₂⁻—N(nitrite)+O₂→Nitrobacter

NO₃⁻(nitrate)

Nitrification consumes alkalinity and lowers pH in the activated sludge mixed liquor. In one example, BNR may be accomplished by the BNR system and process shown and described above in relation to FIG. 1. A minimum effluent alkalinity of 50 mg/L is ideally maintained to prevent inhibition of nitrification. Optimal conditions to achieve nitrification in the activated sludge process include an aerobic mean cell residence time (“MCRT”) of approximately 4 to approximately 15 days; a pH of approximately 6.5 to approximately 8.0, preferably approximately 6.7 to 7.5 (a pH below 6.7 may inhibit nitrification), more preferably approximately 7.0 to approximately 7.5; a temperature of more than approximately 10° C., preferably a temperature of more than approximately 20° C., more preferably approximately 25° C.; and a concentration of dissolved oxygen (“DO”) of greater than approximately 2.0 mg/L in the aerobic zone. As compared to BOD removal, nitrification requires longer MCRT, more oxygen, and more alkalinity. Generally, nitrification requires alkalinity (e.g., HCO₃⁻) and oxygen. Nitrification may double the oxygen requirement relative to a wastewater plant without BNR. As mentioned above, an example alkalinity which would provide adequate nitrification is approximately 7.14 pounds as CaCO₃ per pound of nitrogen oxidized. In an example, with a plant influent flow of 10 million gallons per day (mgd) and a primary effluent Total Kjeldahl Nitrogen (“TKN”=organic nitrogen+ammonia) (total nitrogen=TKN+nitrate+nitrite) of approximately 31.5 mg/L, the alkalinity consumed by nitrification in pounds per day is as follows:

10 mgd×31.5 mg/L×7.14 lb of alkalinity required per lb of ammonia−N nitrified×8.34=18,757 pounds alkalinity as CaCO₃ per day

Nitrification is typically the rate limiting step as compared to denitrification in the BNR process. During denitrification, reduction to molecular nitrogen is attempted by converting nitrate to nitrogen gas, reducing the effluent nitrogen in the waste discharge along with the reduction of ammonia nitrogen. A denitrification reaction may be as follows in an anoxic environment (contains oxidized nitrogen in the form of nitrate/nitrate, but has no dissolved oxygen):

Nitrate anion+methanol→carbon dioxide+nitrogen gas+water+bicarbonate anion

NO₃⁻(nitrate)+CH₃OH (methanol)→Denitrifier

CO₂+N₂(nitrogen gas)+H₂O+HCO₃⁻(alkalinity)

To achieve low effluent nitrogen limits, an optional organic substrate may be added during the denitrification process, e.g., via organic substrate stream 231 from organic substrate tank 232 which may optionally be pressurized using one or more organic substrate pumps 233. This optional organic substrate added to the denitrification process/system may include one or more carbon-containing materials such as methanol, ethanol, acetate, and/or sugar. A preferred organic substrate is methanol.

Alkalinity is produced as a result of denitrification which may or may not be recycled back into the nitrification/denitrification zone. In an example, the alkalinity produced in the denitrification reaction may be approximately 3.57 pounds as CaCO₃ per pound nitrate-N denitrified where the denitrification reaction is as follows:

6NO₃⁻(nitrate)+5CH₃OH(methanol)→5CO₂(carbon dioxide)+3N₂(nitrogen gas)+7H₂O+6OH⁻

The alkalinity recovered by denitrification may be as follows, for example, with a plant influent flow of 10 mgd and a nitrate to be denitrified of 22 mg/L:

10 mgd×22 mg/L×3.57 lb alkalinity recovered per lb nitrate denitrified×8.34=6,550 lb alkalinity as CaCO₃ recovered per day

Example optimal conditions to achieve denitrification include maintaining dissolved oxygen below approximately 0.3 mg/L in the anoxic zone. As dissolved oxygen increases, denitrification rate decreases. Optimal pH conditions to achieve denitrification are within the aforementioned range for nitrification.

Following nitrification/denitrification, one or more optional tertiary clarifiers 235 or other separating devices may be included to remove solid matter and impurities from a BNR product stream 234 exiting from the nitrification/denitrification tank(s) 225. The one or more tertiary clarifiers 235 provide a treated liquid discharge stream 236 (for example treated water), which may exit the system for further treatment, discharge, storage, use, or other disposal, as well as a sludge stream 237 which is ultimately sent to the anaerobic digester 1 and/or the nitrification/denitrification tank 225 for further processing.

In one embodiment, the sludge stream 237 is separated into two streams including the sludge stream 238 and a return stream 239. The sludge stream 238 may be combined with second stream 218 obtained from a portion of the sludge stream 217 from the secondary clarifier 215. This combination of second stream 218 and sludge stream 238 results in combined stream 240 which may be fed into the anaerobic digester 1 for further treatment in the ammonia recovery system ARS. One or more sludge pumps 242 may be used to increase pressure of the sludge stream 237.

The second return stream 239 from the sludge stream 237 may be returned to the nitrification/denitrification tank 225 for further treatment.

During the nitrification/denitrification process, alkalinity is necessary and often is required to be added to the nitrification tank 225A. In the embodiment shown in FIG. 3, the alkalinity produced in the ammonia recovery system and process ARS, which results in the low ammonia, high pH, and high alkalinity return stream R, may be added to the nitrification tank 225A or to some appropriate point in the WPCP prior to tank 225A to reduce or even eliminate additional caustic and alkalinity necessary to effect nitrification. In addition or instead, a portion or all of the return stream R may be added to the denitrification tank 225B. This reduction or elimination of alkalinity added to the waste treatment system by using alkalinity from the ARP reduces the operating costs as well as the capital costs of a waste treatment system and process. Additionally, the return stream R may reduce the amount of organic substrate such as methanol which must be added to the BNR system and process.

In FIG. 4, the embodiments shown in the “Sewage Treatment Process” patent incorporated by reference above may be used to return BOD, in addition to the alkalinity, which can be used by the micro-organisms in the denitrification step. This BOD supplements or replaces methanol or other organic substrate ordinarily added to the denitrification system.

The embodiment of FIG. 4 includes many of the same system components and process steps as described above in relation to FIG. 3. The system components and process steps which are similar or the same as described above in relation to FIG. 3 are numbered with the same numerals in the “200” series, while the variations are numbered by the numerals in the “300” series, these system components and process steps described below.

In the embodiment of FIG. 4, a hydrothermal sludge processing system HPS, as shown and described in the patent “Sewage Treatment System” incorporated by reference above, is included in the waste treatment system to hydrothermally treat a portion of the waste stream in the hydrothermal sludge processing system HPS and produce a hydrothermal solid product 300. The portion of the waste stream which is treated in the hydrothermal system HPS may include the primary sludge stream 208a from the primary clarifier 206 and/or the sludge stream 218 from the secondary clarifier 215 and/or the sludge stream 238 from the tertiary clarifier 235. In this embodiment, these streams 218 and 238 instead of being sent into the anaerobic digester 1 may be flowed to the hydrothermal system HPS.

In general, a preferred hydrothermal sludge processing system HPS includes a sewage treatment system in which a waste stream is separated into a primary sludge and water effluent, and the primary sludge is anaerobically digested and dewatered to produce a Class A biosolid. The water effluent is aerobically digested and separated to provide a waste activated sludge. The waste activated sludge is heated in a two-stage process with steam injection and indirect steam before it is passed to a hydrothermal process. The pH of the treated waste activated sludge is then increased, and the nitrogen is stripped and recovered as an ammonium salt. A low nitrogen stream with volatile fatty acids and soluble organics is then separated and fed to the aerobic digester. Biogas generated during anaerobic digestion provides energy for heating the waste activated sludge for the hydrothermal process, and reject heat from the hydrothermal process heats the primary sludge for thermophilic anaerobic digestion. In one embodiment, hydrothermal sludge processing comprises (1) separating a waste stream into a primary sludge and a water effluent; (2) anaerobically digesting the primary sludge and dewatering the digested primary sludge to convert the primary sludge to a Class A biosolid without subjecting the primary sludge to a hydrothermal process; (3) aerobically digesting the water effluent; (4) separating the digested water effluent to provide a waste activated sludge; and (5) treating the waste activated sludge using a hydrothermal process, in some embodiments without subjecting the waste activated sludge to anaerobic digestion. In other embodiments, hydrothermal sludge processing comprises (1) providing a waste stream comprising at least one nitrogen containing compound, the waste stream being at a first temperature that is less than or equal to approximately 60° C.; (2) injecting steam into the waste stream to preheat the waste stream to a second temperature that is greater than or equal to approximately 255° C.; and (3) if the second temperature is less than approximately 275° C., subjecting the preheated waste stream to indirect steam heating to heat the preheated waste stream to a third temperature that is greater than or equal to approximately 275° C. In some embodiments, hydrothermal sludge processing comprises (1) separating a waste stream into a primary sludge and a water effluent; (2) anaerobically digesting the primary sludge to generate a biogas; (3) treating the water effluent to create a waste activated sludge; (4) combusting the biogas; (5) transferring heat from the combustion of the biogas to the waste activated sludge to create a heated waste activated sludge; and (6) passing the heated waste activated sludge through a heat exchanger to provide indirect heat transfer from the heated waste activated sludge to the primary sludge.

In yet other embodiments, hydrothermal sludge processing comprises (1) separating a waste water stream into a primary sludge and a water effluent; (2) treating the water effluent with biological processes to create a waste activated sludge; (3) combining, thickening, and/or dewatering the undigested primary and waste activated sludges; (4) processing the treated and combined sludges in a hydrothermal reactor; (5) separating the hydrothermally processed sludges into a solids enriched stream and ammonia containing solids depleted stream; (6) capturing ammonia from the solids depleted stream with ARP; and (7) returning the high pH, low ammonia stream from the ARP to a biological process that conducts nitrification.

In one embodiment, the hydrothermal system HPS is configured as shown and described in relation to FIGS. 1 and 2 of the “Sewage Treatment System” patent incorporated by reference herein. The following table represents a flow summary when using the hydrothermal process and system with embodiments disclosed herein, where “dtpd” represents dry tons per day, “wtpd” represents wet tons per day, kW represents kilowatts, MMBtu/d represents millions of British thermal units per day, and “WAS” represents waste activated sludge:

| | dtpd | wtpd | kW | MMBtu/d |
|---|---|---|---|---|
| Inputs to Hydrothermal Process | | | | |
| WAS | 33.4 | 557 | | |
| Natural Gas | | | | 206 |
| Electricity | | | 112 | |
| Outputs from Hydrothermal Process | | | | |
| Cake | 7.5 | 10 | | |
| Recycled Organics | 7 | 380 | | |
| Recycled Ammonia | 3 | | | |
| Optional Inputs for Ammonia Capture | | | | |
| Caustic | 6 | 17 | | |
| Sulfuric Acid | 12 | 20 | | |
| Optional Outputs with Ammonia | | | | |
| Capture | | | | |
| Ammonium Sulfate | 12 | 51 | | |
| Alkalinity Return | 3 | 380 | | |

Caustic and/or another basic substance is added to the hydrothermal system HPS, for example via the caustic pump 202 from the caustic tank 37. In this embodiment, the caustic stream 11 may be split into two streams, a first caustic stream 301 flowing into the hydrothermal system HPS and a second caustic stream 302 flowing into the ammonia recovery system ARS. As described and shown in the Sewage Treatment System patent, at least a portion of the contents of the hydrothermal System HPS in the form of a product stream 303 exits from the hydrothermal system HPS and becomes hydrothermal solid product 300. Additionally, a return stream 305 may be returned to the ammonia recovery system ARS for further processing within the waste treatment system.

Also shown in FIG. 4, in addition to the low ammonia (may be from approximately 0 ppm to approximately 300 ppm ammonia), high pH (may be from approximately 9 to approximately 12), and high alkalinity (may be from approximately 500 ppm to approximately 20,000 ppm) return stream R being returned to the nitrification tank 225A, a low ammonia (may be from approximately 0 ppm to approximately 300 ppm ammonia), high BOD (may be from approximately 300 to approximately 30,000), high pH (may be from approximately 9 to approximately 12), and high alkalinity (may be from approximately 500 ppm to approximately 20,000 ppm) return stream R2 is returned to the denitrification tank 225B to reduce the oxygen demand of the denitrification process. This return stream R2 reduces or eliminates the need for external addition of methanol or other organic substrate into the nitrification/denitrification process and system, decreasing operating and capital costs.

With embodiments of the above-described ammonia recovery process, the product ammonium sulfate 204 may be utilized as a commercial grade fertilizer. The nitrogen in the form of ammonia found in the waste stream is thereby efficiently and cost-effectively converted to a usable product by use of the above-described methods and apparatus. The recovery of ammonia in the form of ammonium sulfate or in any other form using the above-described methods and apparatus advantageously limits nitrogen discharge into bodies of water, as often required by environmental regulations, along with providing a usable end-product (e.g., ammonium sulfate). The ammonium sulfate (or other formed product) is capable of being crystallized to form a pure product.

The ARP, as shown and described in the above-incorporated-by-reference patent applications, may be utilized as a stand alone technology for the removal of ammonia from concentrated waste streams or may be used in conjunction with the BNR. Cost estimates for removal of about 90% of the centrate ammonia for the 85 mgd plant of New York City Department of Environmental Protection (“NYC DEP”) (26^{th} Ward) indicate that in some examples of embodiments, a capital cost of $15 million for centrate treatment would accomplish the same reduction as would a capital cost of $115 million for BNR applied to the main stream. Estimates of operating costs similarly indicated large reductions in costs for energy, chemicals, and sludge disposal.

In the examples below, operating benefits for embodiments including side-stream treatment of centrate and the impact of centrate side-stream treatment with ARP on inputs needed for BNR are illustrated. The examples display the process inputs required to achieve a desired level of ammonia removal by the water pollution control plant (“WPCP”).

Contemporary WPCP are often multi-stage bio-chemical facilities, with complex interaction of the stages. Simple linear reasoning may be inadequate to describe the ecology of the active organisms, which controls operation at aerobic secondary treatment, anoxic and aerated zones of nutrient reduction, and the anaerobic digesters. Consideration of the feedback of intermediate streams and the behavior of clarifiers, separators, and dewatering devices reinforces the conclusion that a simulation that accounts for these phenomena is desired for a realistic computational model. The most widely used simulation software, and the one used for most NYC DEP models, is BioWin. BioWin simulations were conducted to estimate the impact of ARP use on the inputs required for reduction of the ammonia effluent from a typical WPCP. All example simulations were for steady-state operation at approximately 20° C.

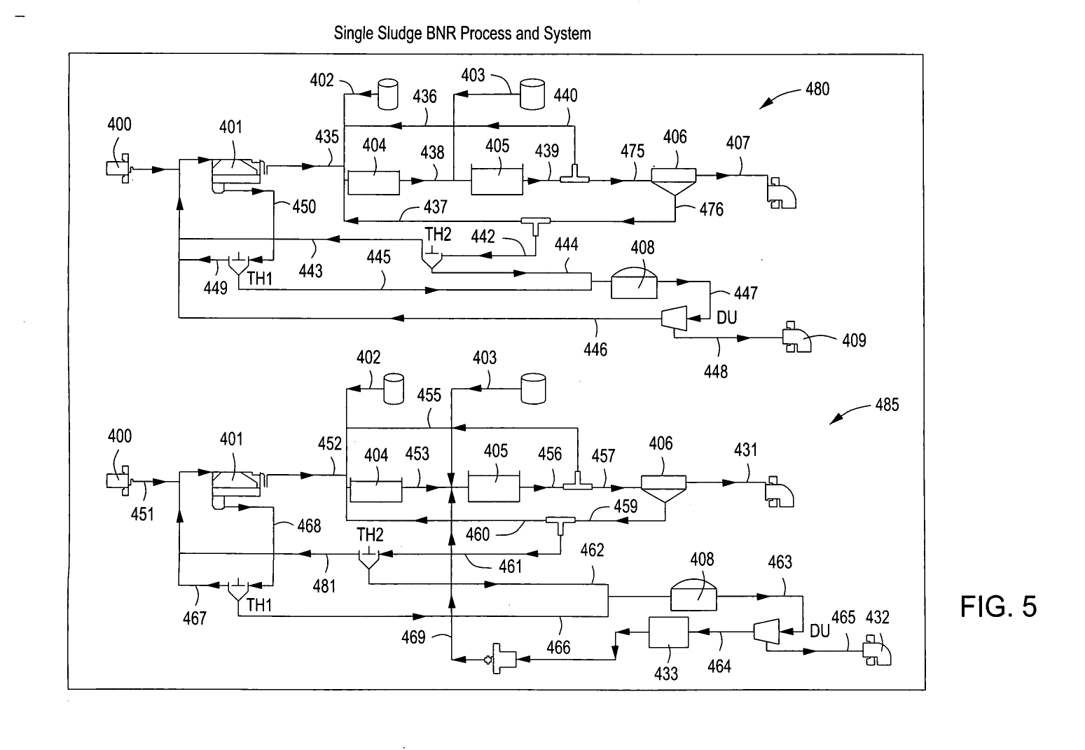

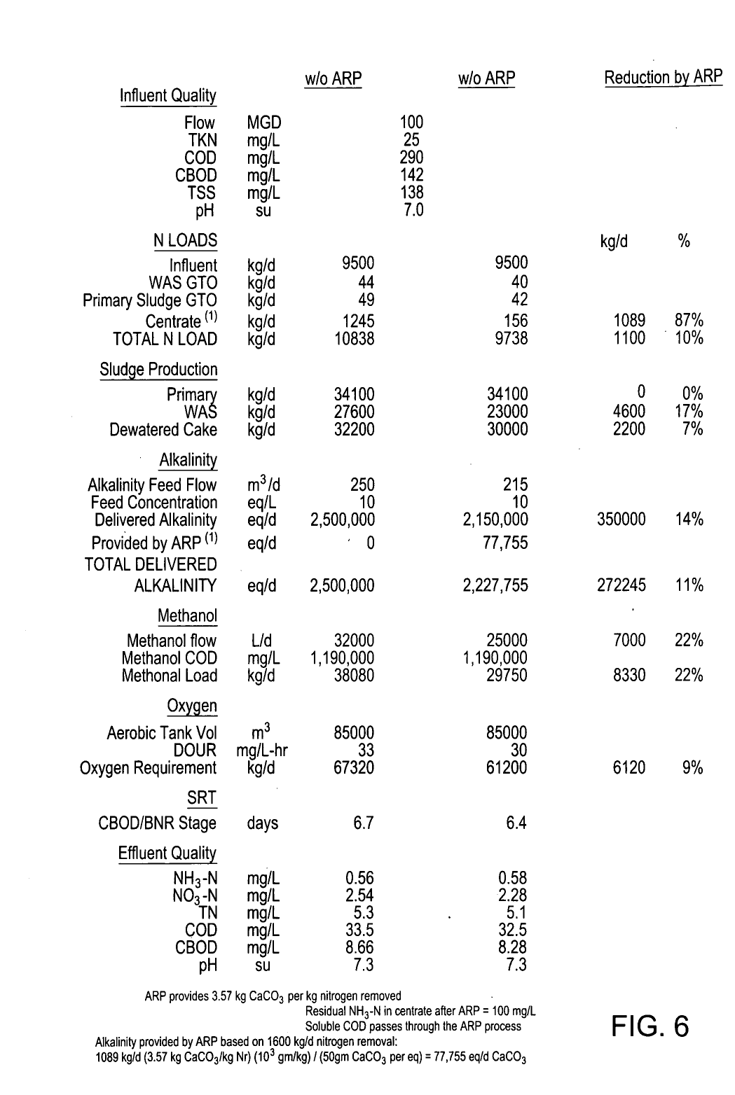

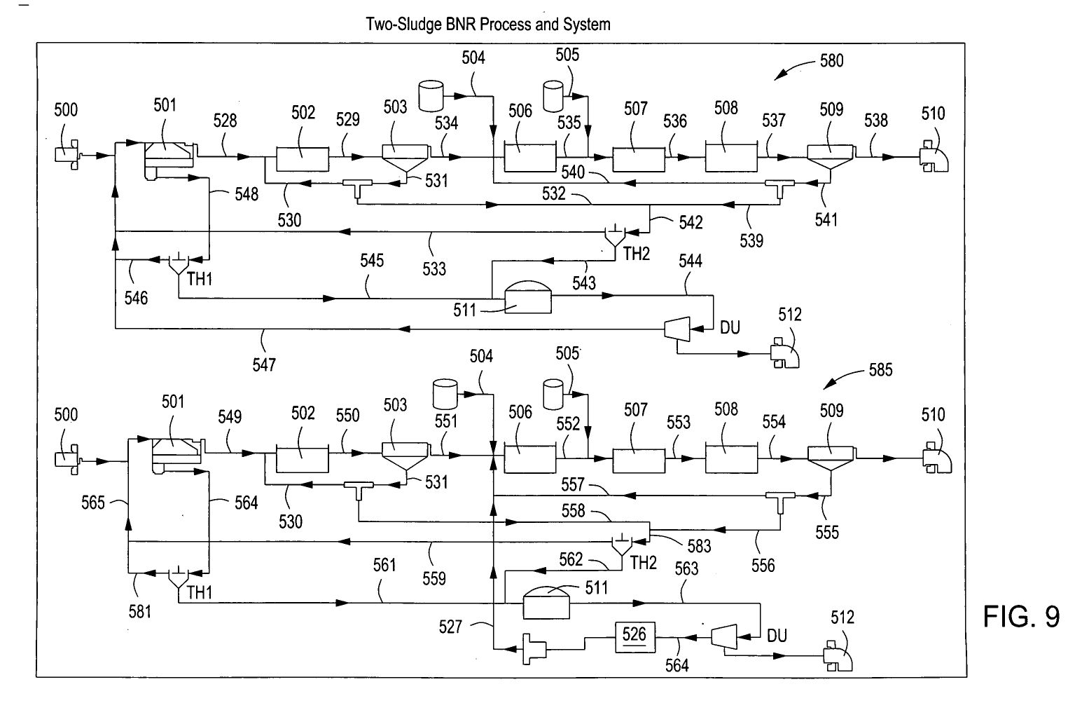

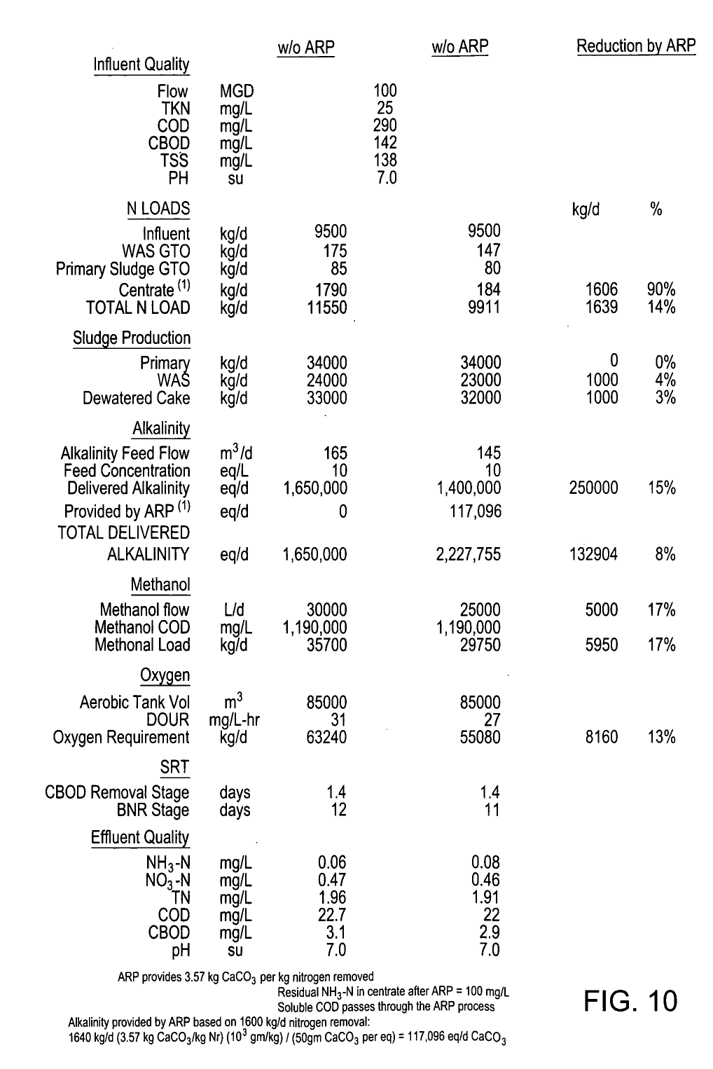

In examples, the impact of embodiments on two broad categories of WPCP were studied: single-sludge plants, such as those of NYC DEP, in which modification of the secondary treatment is employed for nutrient reduction (depicted in FIG. 5), and two-sludge plants, such as the Blue Plains plant, in which a separate treatment train is used for nutrient reduction (depicted in FIG. 9). Generic 100 mgd models were used for each of these categories, and performance of an example of each category was used to adjust the model operation parameters to match typical centrate ammonia concentration. Parameters were specified in the generic model for each category using default values for rate constants, tank volumes, etc., and identical influent characteristics were used for the two categories of plant. Total nitrogen in plant effluent of approximately 5 parts per million (“ppm”) was achieved for the single-sludge model and approximately 2 ppm for the two-sludge case. The computational results of testing on embodiments are displayed for the single-sludge case in FIG. 6 and for the two-sludge case in FIG. 10.

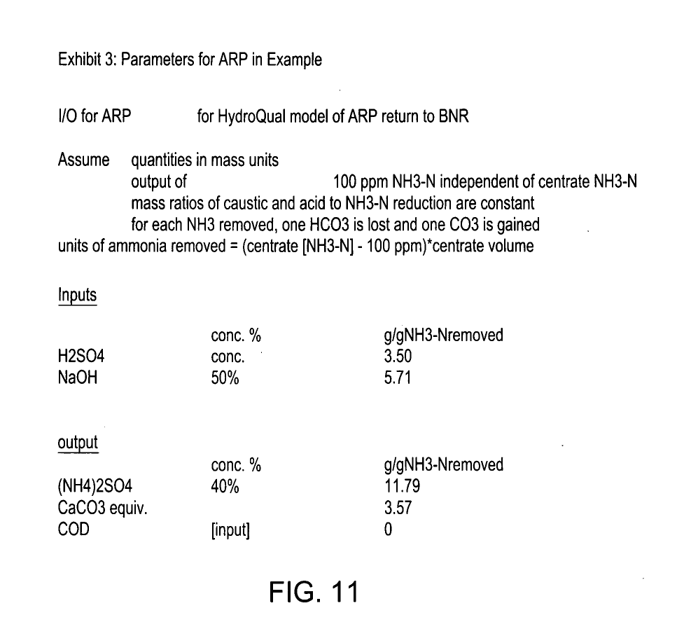

ARP is itself a sequence of steps that may be dependent on both the waste stream to be treated and the effluent specifications. An embodiment of ARP to be modeled for centrate treatment in these examples takes the effluent from the vacuum separation step as the return stream to the sewage treatment plant. This taking of the effluent preserves the alkalinity of that stream to be used in the plant's BNR, while returning a stream with approximately 100 ppm of ammonia. The effect of this application of ARP treatment of the centrate on chemical and energy inputs was projected for each category of plant. The model for each category was modified to include ARP as shown in FIGS. 5-8. Centrate flow to the head of the plant was eliminated in the ARP models, and the ARP treated centrate was introduced as a flow to the start of the BNR process. The chemical and oxygen inputs to the BNR process were adjusted in order to keep effluent nitrogen the same for ARP and non-ARP results. Oxygen demand was taken as a surrogate for energy use since the major energy benefit of ARP is the decrease in aeration required. A conservative estimate of caustic demand for ARP based on full conversion of centrate bicarbonate to carbonate was employed. Input and output for ARP and parameters for ARP in these example models are displayed in FIG. 11.

In order to properly interpret the model results it is important to take into account the sensitivity to the model parameters. In these examples, the model parameters varied were influent Total Kjeldahl Nitrogen (“TKN,” or the sum of ammonia and organic nitrogen); solids retention time in secondary process for single-sludge, and the values for both secondary and BNR processes for two-sludge (“SRT”); and total solids input to the anaerobic digester (“TS”). Each of these parameters influences the solids sent to the anaerobic digester and thereby the ammonia influent to the ARP. These results are discussed in the following sections.

In these examples, identical influent streams are assumed for the two plant categories. The impact of ARP on plant operations is measured by changes in the following set of variables for each category, as shown in Table 2:

TABLE 2

| Input to Model of | |
|---|---|
| WPCP | Definition |
| Total N Load | Total nitrogen input to BNR = influent-N + |
| | recycled-N |
| Sludge Produced | Total sludge output from plant |
| Alkalinity | Total alkalinity required for nutrient reduction |
| Methanol | Methanol required for the denitrification step |
| | of BNR |
| Oxygen | Oxygen input to BOD reduction and to the |
| | nitrification step of BNR |

The nitrogen load (“N load”) on the BNR process for either category of plant includes recycled centrate (and small amounts from other recycle streams) as well as influent nitrogen. Typically nitrogen in recycled centrate is about 20-40% of the total N load. Sludge produced by the plant is reduced by ARP treatment of the centrate, as less or no additional bacterial growth in the BNR is needed to treat the ammonia removed by ARP. Alkalinity demand is similarly reduced in the BNR by the removal of ammonia by ARP, while approximately half of the alkalinity added for ARP is available for use in the treated centrate that is recycled to the BNR process. Methanol demand is reduced as well by the removal of ammonia by ARP, but in addition the soluble carbon made available by anaerobic digestion is not affected by ARP and is returned to the BNR as bio-available carbon replacing an equivalent amount of methanol. Finally, the oxygen demand is lowered by the reduced load caused by removal of ammonia by ARP.

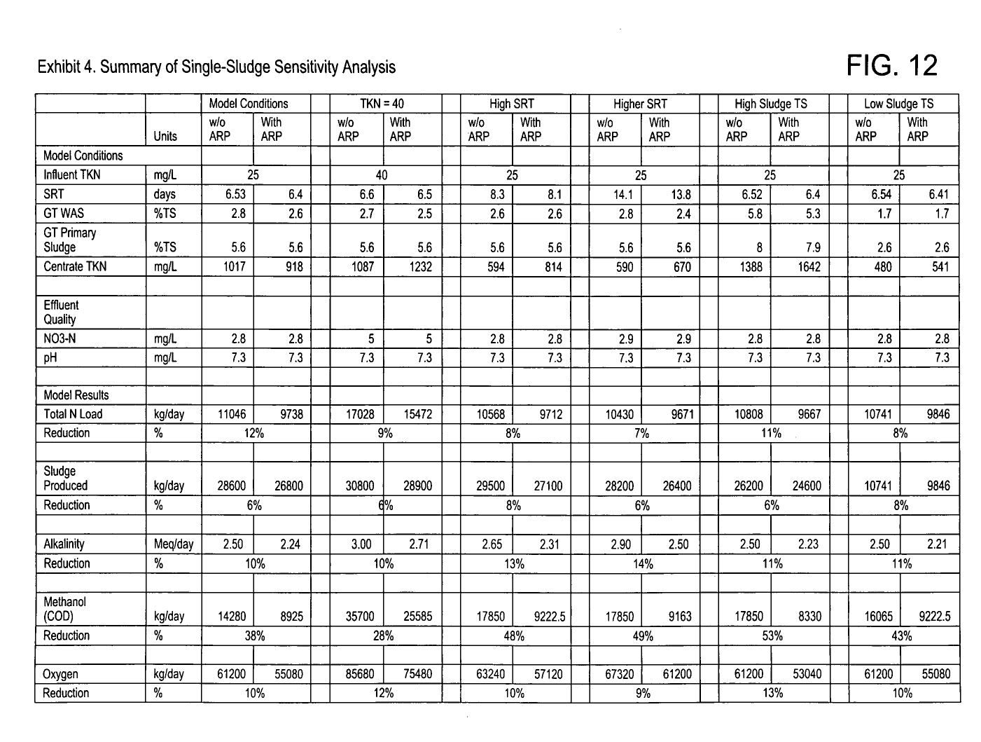

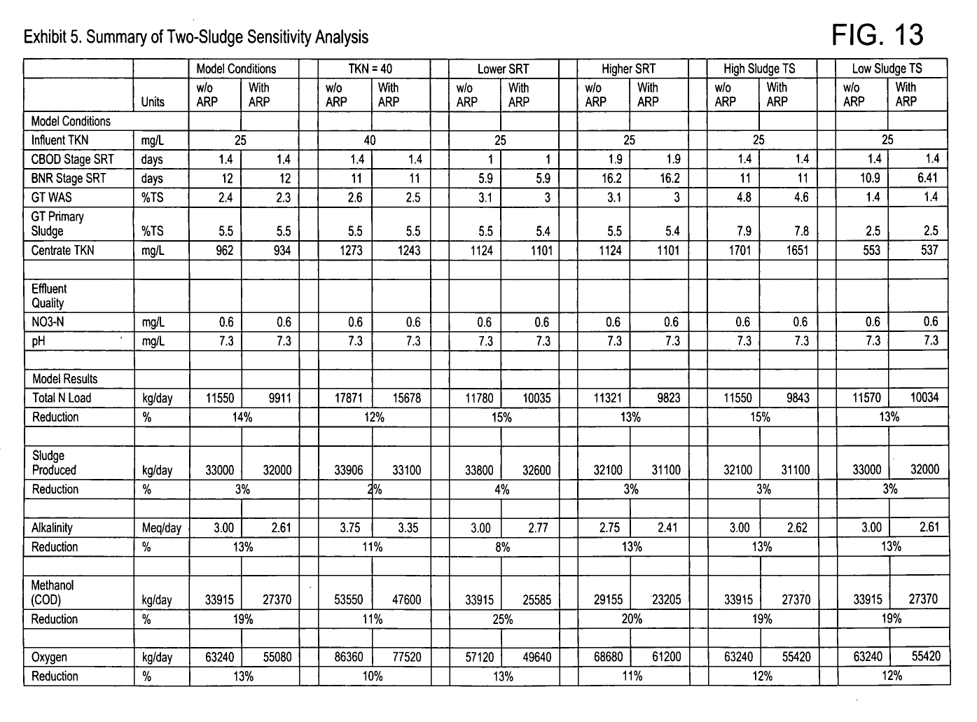

The sensitivity of the effect of ARP on each of these input requirements is also presented for each category of WPCP in FIGS. 12 and 13.

The following few paragraphs involve examples conducted using the single-sludge plant. The single-sludge plant, as shown in FIG. 5, adapts secondary treatment to achieve nitrification and denitrification. FIG. 5 shows a single-sludge BNR process and system, including a first BNR process and system 480 which does not include ARP as described above. The first BNR process and system 480 without ARP example includes an influent waste stream 400 flowable into a primary clarifier tank 401 or other storage/clarification unit. A first clarified stream 435 (which may be a BOD-containing stream) and a primary sludge stream 450 are flowable from the primary tank, the first clarified stream 435 (which may be a BOD-containing stream) flowable into an anoxic zone 404 for denitrification. The primary sludge stream 450 may be treated in a thickener TH1 where it is converted into a solids-enriched stream 445 and a solids-depleted stream 449. The solids-enriched stream 445 is further processed in an anaerobic digester while the solids-depleted stream 449 is returned to the primary clarifier 401. Optionally, a carbon source such as methanol 402 may be available for flowing into the anoxic zone 404 to aid in denitrification. A stream 438 (which may be an anoxically treated stream) is flowable from the anoxic zone 404 into an aerobic zone 405 where nitrification occurs. Optional alkalinity may be added via alkalinity stream 403 to achieve nitrification. A stream 439 (which may be an aerobically treated stream) exits from the aerobic zone 405 and may be split into a recycle stream 440 which is flowable back into the anoxic zone 404 for further nitrification and/or denitrification treatment and a partially treated stream 475 which is flowable into one or more separators such as one or more clarifiers 406. The clarifier separates solids depleted clarified effluent stream 407 and solids enriched activated sludge stream 476 (AS stream) from one another.

Treated clarified effluent stream 407 exits the single-sludge BNR process and system for further treatment, storage, use, or disposal. The AS stream 476 may be split into two streams, a recycled sludge stream 437 and a waste sludge stream 442. The waste sludge stream 442 may be further processed in a thickener into a solids enriched stream 444 and a solids depleted stream 443. The solids enriched stream 444 may be further processed in one or more anaerobic digesters 408, while the solids depleted stream 443 may be returned to the primary clarifier 401. An anaerobically digested stream 447 which exits from the anaerobic digester 408 may be split into a high solids digested sludge cake stream 448 and a high ammonia centrate stream 446, the return stream 446 having a high ammonia content which may be from approximately 500 ppm to approximately 2,500 ppm. The sludge cake stream 448, which preferably has a high solids content to include from approximately 10 percent to approximately 35 percent solids, is sent out for disposal or reuse as sludge cake 409. The return high ammonia centrate stream 446 is ultimately flowable back into the primary tank 401 (prior to reaching the primary tank, the return stream 446 may merge with the stream 443 and/or an optional return stream 449). The results of performing the BNR process and system 480 without ARP according to the above example are shown in the table of FIG. 6.

A second BNR process and system 485 includes ARP 433 which may be retrofitted to an existing system such as the system 480. An influent waste stream 400 is optionally flowable into a clarifier tank 401, A first BOD containing stream 452 and a first sludge stream 468 are flowable from the primary tank, the first BOD containing stream 452 flowable into an anoxic zone 404 for denitrification. The primary sludge stream 468 may be treated in a thickener where it is converted into a solids enriched stream 466 and a solids depleted stream 467. The solids enriched stream 466 is further processed in an anaerobic digester while the solids depleted stream 467 is returned to the primary clarifier 401. Optionally, a carbon source such as methanol 402 may be available for flowing into the anoxic zone 404 to aid in denitrification. An anoxically treated stream 453 is flowable from the anoxic zone 404 into an aerobic zone 405 where nitrification occurs. Optional alkalinity may be added via alkalinity stream 403 to achieve nitrification. An aerobically treated stream 456 exits from the aerobic zone 405 and may be split into a recycle stream 455 which is flowable back into the anoxic zone 404 for further nitrification and/or denitrification treatment and a partially treated stream 457 which is flowable into one or more separators such as one or more clarifiers 406. The clarifier separates treated effluent stream 431 (clarified effluent stream) and second sludge stream 459 (AS stream) from one another.

Treated effluent stream 431 exits the single-sludge BNR process and system for further treatment, storage, use, or disposal. The second sludge stream 459 may be split into two streams, a recycled sludge stream 460 and a waste sludge stream 461. The waste sludge stream 461 may be further processed in a thickener into a solids enriched stream 462 and a solids depleted stream 481. The solids enriched stream 462 is further processed in an anaerobic digester while the solids depleted stream 481 is returned to the primary clarifier 401. An anaerobically digested stream 463 which exits from the anaerobic digester 408 may be split into a high solids digested sludge cake stream 465 and a return high ammonia (may include from approximately 500 to approximately 2,500 ppm ammonia) centrate stream 464. The high solids (which may include from approximately 10% to approximately 35% solids digested) sludge stream 465 (dewatered sludge stream) becomes sludge cake 432, while the return high ammonia centrate stream 464 is sent to the ARS 433. The ARS returns a high alkalinity (which may include from approximately 500 ppm to approximately 10,000 ppm alkalinity) and low-ammonia (which may include from approximately 0 to approximately 300 ppm ammonia) stream 469 to the BNR process. Stream 469 may be returned to the BNR process at any appropriate point but preferably the aerobic tank 405 or prior to the aerobic tank 405. The return of a centrate with low ammonia and high alkalinity in the BNR with ARS case 485 as compared to the baseline BNR case of 480 yields a savings of methanol, aeration air, alkalinity and processing capacity. The results of performing the BNR process and system with ARP 480 according to the above example are shown in the table of FIG. 6.

This secondary treatment performed using the single-sludge plant shown in FIG. 5 allows considerable capital cost savings in retrofit of existing equipment, but comparison of FIG. 12 showing the single-sludge sensitivity analysis with FIG. 13 (the two-sludge sensitivity analysis) shows that for this generic model it requires higher inputs for nitrogen removal. The left two columns, Base Case, of FIG. 12 demonstrate the ability of ARP to substantially reduce the input requirements for this category of plant. The percent reduction of sludge produced is less than the reduction in N load, since BNR is not the only source of bio-solids. Methanol reduction exceeds the reduction of nitrogen load since treated centrate and influent provide a source of bio-available carbon. Reduction of the nitrogen load to the equivalent of this available carbon should eliminate the methanol demand.

The generic model single-sludge system produced a centrate nitrogen (“centrate-N”) load of about 10% of influent TKN, whereas NYC DEP plants typically have centrate-N loads of about 20%. Although a site-specific model may be required for accurate estimation of savings to be achieved at a specific plant, the substantial percent reductions in sludge production, chemical inputs, and aeration are expected to be similar at an actual plant, as indicated by the sensitivity results delineated in FIG. 12.

The next paragraph involves examples using the two-sludge plant. The two-sludge plant dedicates a separate process to nutrient reduction, as shown in FIG. 9. FIG. 9 shows a two-sludge BNR process and system 580 without ARP. A primary tank 501 or other unit is capable of receiving an influent waste stream 500 and separating it into a first clarified stream 528 and a primary sludge stream 548. The primary sludge stream 548 may be treated in a thickener TH1 where it is converted into a solids enriched (thickened) stream 545 and a solids depleted stream 546, which may be recycled back into the primary tank 501 for further treatment, and thickened stream 545 flowable into one or more anaerobic digesters 511.

The first clarified stream 528 is flowable into a carbonaceous biological oxygen demand (“CBOD”) zone 502. The CBOD zone 502 is used to achieve carbonaceous BOD removal in an activated sludge process. In CBOD removal in the activated sludge process, influent containing organic material and return sludge containing bacteria are hydrolyzed by heterotrophic bacteria to change organic-N to ammonium-N, and heterotrophic aerobic bacteria utilize oxygen, organic material, ammonium-N, and ortho-P to produce carbon dioxide, water, and more bacterial cells. The aeration tank effluent is typically low in soluble organics. Minimum conditions to maintain CBOD removal in the activated sludge process may include the following: mean cell residence time of approximately 0.5 days to approximately 1 day, pH of approximately 5 to approximately 9, temperature above freezing, and dissolved oxygen of above approximately 0.5 mg/L.

An effluent reduced-carbon stream 529 exits from the CBOD zone 502 and may be flowed into one or more separators such as one or more first clarifiers 503, where it may be separated into a clarified stream 534 and an activated sludge stream 531. The activated sludge stream 531 may be split into a return stream 530 which is returned into the CBOD zone 502 and a waste sludge stream 532 which may be thickened in TH2 and is ultimately flowed via sludge stream 543 into the one or more anaerobic digesters 511.

The clarified stream 534 is flowable into the nitrification and/or denitrification zone (nitrification/denitrification zone). The nitrification/denitrification zone includes Nit 1-2 oxic zone 506 where alkalinity 504 may be added to effect nitrification pH control, Nit 3-4 anoxic zone 507 where a carbon source such as methanol 505 may be added to effect denitrification, and Nit 5 re-aeration zone 508 where the dissolved oxygen concentration may be increased. Nitrified stream 535 is flowable from the Nit 1-2 oxic zone 506 and into the Nit 3-4 anoxic zone 507, denitrified stream 536 is flowable from the Nit 3-4 anoxic zone 507 into the Nit 5 re-aeration zone 508, and partially treated stream 537 is flowable from the Nit 5 re-aeration zone 508 into one or more optional second clarifiers 509 or other separating devices. The second clarifier 509 is capable of separating the partially treated stream 537 into a treated effluent stream 510 and a solids enriched sludge stream 541.

The treated effluent stream 510 may exit the two-sludge BNR process and system 580 for further treatment, storage, use, or disposal. The sludge stream 541 may be separated into a return sludge stream 540 and a waste sludge stream 539. The sludge stream 540 may be returned into the nitrification/denitrification zone, for example at the beginning of the Nit 1-2 zone 506, and the sludge stream 539 may be combined with the sludge stream 532 to form sludge stream 542. Sludge stream 542 may be separated into solids-depleted stream 533 and a thickened sludge stream 543 by thickener TH2. The thickened sludge stream 543 may be fed into the anaerobic digester 511 along with the thickened stream 545. The solids-depleted stream 533 may be fed back into the primary tank 501 for further treatment.

Anaerobically digested stream 544 which exits from the anaerobic digester 511 is separable into a sludge stream forming sludge cake 512 and a return stream 547 which may be recycled back into the primary tank 501. This return stream 547 may optionally be combined with return stream 546 and solids-depleted stream 533 prior to flowing the combined stream back into the primary tank 501. The results of performing the two-sludge BNR process and system 580 without the ARP are shown in the table of FIG. 10.

FIG. 9 also shows an example two-sludge BNR process and system 585 with ARP. The two-sludge BNR process and system 585 may optionally be retrofitted with an ARP 526.

In the example shown in FIG. 9, a primary tank 501 or other unit is capable of receiving an influent waste stream 500 and separating it into a first clarified stream 549 and a primary sludge stream 564. The sludge stream 564 may be separated into a first return stream 581 which may be recycled back into the primary tank 501 for further treatment by the BNR process and system 585 and a thickened sludge stream 561 flowable into an anaerobic digester 511.

The first clarified stream 549 is flowable into a carbonaceous biological oxygen demand (“CBOD”) zone 502. An effluent reduced-carbon stream 550 exits from the CBOD zone 502 and may be flowed into one or more separators such as one or more first clarifiers 503, where it is separable into a clarified stream 551 and a sludge stream 531. The sludge stream 531 may be split into a return stream 530 which is returned into the CBOD zone 502 and a sludge stream 558 which is ultimately flowable via sludge stream 562 into the anaerobic digester 511.

The clarified stream 551 is flowable into the nitrification/denitrification zone. The nitrification/denitrification zone includes Nit 1-2 oxic zone 506 where optional alkalinity 504 may be added, Nit 3-4 anoxic zone 507 where optional carbon source such as methanol 505 may be added, and Nit 5 re-aeration zone 508. Nitrified stream 552 is flowable from the Nit 1-2 oxic zone 506 and into the Nit 3-4 anoxic zone 507, denitrified stream 553 is flowable from the Nit 3-4 anoxic zone 507 into the Nit 5 re-aeration zone 508, and stream 554 is flowable from the Nit 5 re-aeration zone 508 into one or more second clarifiers 509 or other separating devices. The second clarifier 509 is capable of separating the partially treated stream 554 into a treated effluent stream 510 and a sludge stream 555.

The treated effluent stream 510 may exit the two-sludge BNR process and system 585 for further treatment, storage, use, or disposal. The sludge stream 555 may be separated into a return stream 557 and a waste sludge stream 556. The return stream 557 may be returned into the nitrification/denitrification zone, for example at the beginning of the Nit 1-2 oxic zone 506, and the waste sludge stream 556 may be combined with the sludge stream 558 to form waste sludge stream 583. Waste sludge stream 583 may be separated into a solids-depleted stream 559 and a thickened sludge stream 562. The sludge stream 562 may be fed into the anaerobic digester 511 along with the sludge stream 561. The solids-depleted stream 559 may be fed back into the primary tank 501 for further treatment.

Anaerobically digested stream 563 which may exit from the anaerobic digester 511 is separable into a sludge stream forming sludge cake 512 and an anaerobically digested stream 564 which is flowed into the ARP 526. ARP effluent 527 having alkalinity and/or carbon source therein may be added to the nitrification/denitrification zone to aid in the nitrification/denitrification of the waste stream, thereby reducing alkalinity and carbon source that must be added to the nitrification/denitrification zone to effect nitrification/denitrification. The return stream 581 and the return stream 559 may optionally be combined into return stream 565, which may be added to the primary tank 501 for further treatment of the return stream 565. The results of performing this example two-sludge BNR process and system 585 with the ARP are shown in the table of FIG. 10.

The generic models and examples shown and described above demonstrate that the two categories of plant have materially different benefits from the application of ARP. BNR recycle in the single-sludge category lowers demand for addition of both alkali and methanol relative to the two-sludge category. While the reduction of methanol demand in these examples is over 6000 kilograms per day (“kg/d”) for the two-sludge and about 5300 kg/d for the single-sludge model, the percent reduction calculated for the single-sludge model is much higher in this example due to the lower overall demand for the single-sludge category. A similar result was obtained for the alkali demand.

Substantial benefits are attained for centrate treatment by ARP for either a single-sludge or a two-sludge plant, as evidenced by the generic example model calculations. Sensitivity computations in FIGS. 12 and 13 demonstrate that this conclusion is robust. Approximate reductions in sludge production and process inputs are shown below in Table 3:

TABLE 3

| | Single | |
|---|---|---|
| Model Results | sludge | Two Sludge |
| Sludge Reduction | 6% | 3% |
| Alkalinity Reduction | 10% | 13% |
| Methanol Reduction | 38% | 19% |
| Oxygen Reduction | 10% | 13% |

These results are indicative of substantial savings in both operating cost and energy use when ARP is integrated into the nutrient reduction design for an actual benefit. The above calculations represent generic examples in cost savings; a more realistic estimate of cost savings for a specific plant requires use of actual plant parameters in the examples and calibration of the examples to match plant operational data, as well as unit prices for the process inputs and outputs for the specific plant location. The additional cost savings (outputs) with embodiments may include cost avoidance for transport and disposal of sludge, and also revenue from sale of the ammonium sulfate produced by ARP.

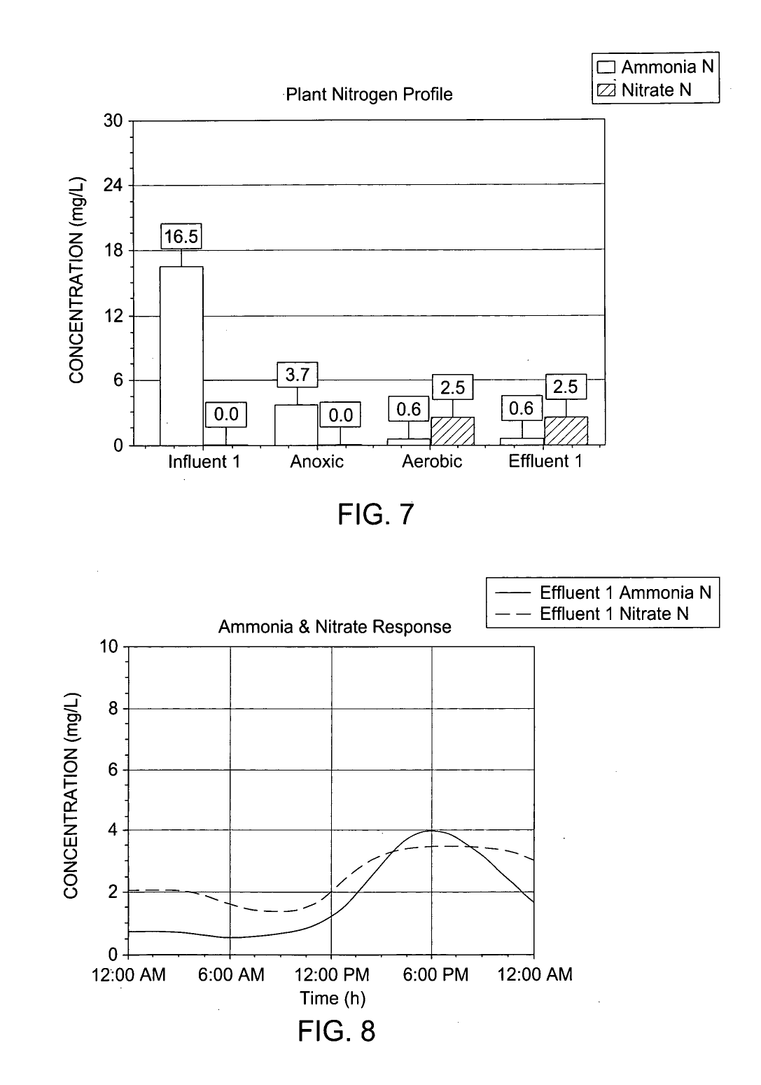

FIG. 7 illustrates the plant nitrogen profile, showing ammonia nitrogen and nitrate nitrogen concentrations in the influent, anoxic zone, aerobic zone, and effluent in the above example. FIG. 8 illustrates ammonia and nitrate response time versus concentrations of effluent ammonia nitrogen and nitrite nitrogen.

Embodiments included herein beneficially reduce TKN load, reduce sludge production, and reduce the amount of added alkalinity, carbon substrates such as methanol, and oxygen to the system and process. A key to achieving these benefits may be maximizing centrate ammonia concentration. Because the examples use a fixed ARP effluent ammonia concentration (approximately 100 mg/L for example), the effectiveness of ARP on centrate ammonia reduction is proportional to the centrate ammonia concentration. Maximizing the centrate ammonia concentration will maximize the benefit of the ARP. Maximizing the centrate ammonia may be achieved by maximizing the sludge total solids (“TS”) concentration by thickening of the digester feed. Maximizing sludge TS concentration may be accomplished by increasing the primary sludge concentration up to approximately 5.5% TS and the waste sludge stream up to about 2.5% TS via one or more optional thickeners. In the examples, digester volatile suspended solids (“VSS”) destruction, which releases the ammonia that ultimately is disposed in the centrate, may be approximately 58% to approximately 59% for the two-sludge process and system and approximately 53% to approximately 54% for the single-sludge process and system. This difference in VSS destruction may be related to a higher level of endogenous cell destruction in the single-sludge anoxic zone than in the two-sludge anoxic zone. These results are also evident in the approximately 80% mixed liquor VSS (“MLVSS”) in the two-sludge system example and approximately 72% MLVSS in the single-sludge system example.

Capital operating costs of the combined ARP and BNR system and process shown and described herein are advantageously less than the capital and operating costs of the standard BNR system and process. Furthermore, the combined ARP and BNR system and process shown and described herein produce a smaller energy and greenhouse gas footprint as well as actual footprint than the standard BNR system and process. Additionally, in embodiments herein the formed ammonium sulfate may be beneficially reused and the secondary treatment may advantageously be operated at a low dissolved oxygen (“DO”) and low sludge retention time (“SRT”) for maximum micro-organism growth and nitrogen uptake.

Cost savings of embodiments may be enhanced by denitrification sludge nitrogen that is recycled through the digester, thereby forming more ammonia-laden centrate (estimated additional ammonia-laden centrate formed due to the recycle is approximately 9% to approximately 12%). The methanol (or other hydroxyl) produces micro-organisms about 0.40 times the COD of the methanol, and these excess micro-organisms generate additional sludge in the one or more clarifiers or other separating devices which generates more ammonia and centrate after it is digested.

In any of the above embodiments, anoxic zones may be located at the downstream end of the activated sludge tank and/or the upstream end of the activated sludge tank. The nitrification/denitrification zones of the above embodiments may include post-denitrification using an anoxic zone at the end of the activated sludge tanks, for example a three stage nitrogen removal process and system post denitrification, or the zones may include instead a single stage nitrogen removal process post-denitrification.

Other embodiments may include pre-denitrification using an anoxic zone at the beginning of the activated sludge tanks such as the Ludzack-Ettinger (“LE”) process or Modified Ludzack-Ettinger (“MLE”) process known to those skilled in the art. Yet other embodiments may include step feed denitrification, where primary effluent is fed at multiple places along the tank to provide a carbon source for denitrification. Other embodiments may include cyclic nitrogen removal (“CNR”) using alternating periods of aerobic and anoxic conditions in the same tank, such as cyclically aerated and mixed tank, Schreiber process, oxidation ditch process, and/or sequencing batch reactors (“SBRs”). Other denitrification configurations for total N levels of about 3 mg/L to about 5 mg/L may include Bardenpho, enhanced MLE, and/or MLE with denitrification filter. Other BNR technologies which may be utilized as the BNR process and system in embodiments include integrated fixed-film hybrid systems using media such as rope media (Ronglace), sponge media (Captor), or web media (Bioweb); high-rate biofilters such as Biofor, Biosytr, or CoLox System; moving bed biofilm reactors (“MBBR”) using plastic carrier elements and without return sludge such as Kaldnes; or membrane bioreactors such as Zenon which use membranes to separate filtrate from the mixed liquor. Yet other embodiments may include BNR and excess phosphorus removal such as by A2/O process, Virginia Initiative Pilot (“VIP”) process, or 5-stage modified Bardenpho process. Embodiments of the above-described and illustrated process may be applicable to any BNR schemes, systems, configurations, and processes known to those skilled in the art. Exemplary BNR schemes, systems, configurations, and processes known to those skilled in the art which are usable with embodiments disclosed herein may include those illustrated and described in Design of Municipal Wastewater Treatment Plants, Volume II, WEF Manual of Practice No. 8, ASCE Manual and report on Engineering Practice No. 76, 1992, in particular pages 92-1012, which are hereby incorporated by reference herein in their entireties.

Advantageously, ARP may be implemented immediately in an existing wastewater plant to take the load off of the plant while more major BNR modifications to the plant are completed, thereby ensuring minimum impact of plant performance during the upgrade of the process and system.

It is within the scope of embodiments that any of the above-described embodiments may include either recovery of denitrification alkalinity or no recovery of denitrification alkalinity for return back into the BNR process and system. While the foregoing is directed to embodiments of the present invention, other and further embodiments of the invention may be devised without departing from the basic scope thereof, and the scope thereof is determined by the claims that follow.

1. A method of removing ammonia from a stream, comprising:
separating a nitrogen containing stream into a first solids-depleted stream and a first solids-rich stream;
treating the first solids-rich stream with anaerobic digestion to produce an ammonium containing treated solids-rich stream;
separating the treated solids-rich stream into a second solids-rich stream and an ammonium containing second solids-depleted stream;
using an ammonia recovery process for removing the ammonia from the second solids-depleted stream, comprising:
adding a sufficient amount of one or more bases to the second solids-depleted stream to convert the ammonium to ammonia and the bicarbonate to carbonate, and
transforming the ammonia into the vapor phase and subsequently collecting the ammonia in a liquid stream using one or more vapor removal devices, thereby separating the liquid ammonia stream from a return stream;
conducting a biological process to remove ammonia from the first solids-depleted stream, the biological process comprising a nitrification process; and
flowing the return stream into the biological process.

2. The method of claim 1, wherein the biological process further comprises a denitrification process.

3. The method of claim 1, wherein the return stream comprises alkalinity concentration in a range of from approximately 500 parts per million to approximately 20,000 parts per million.

4. The method of claim 3, wherein the return stream comprises a pH in a range of from approximately 9 to approximately 12.

5. The method of claim 1, wherein the return stream comprises ammonia concentration in a range of from approximately 0 to approximately 300 parts per million.

6. The method of claim 2, wherein flowing the return stream into the biological nitrogen removal process comprises flowing the return stream into the nitrification process to provide at least a portion of alkalinity required during nitrification reactions and at least a portion of hydroxyl required during denitrification reactions.

7. The method of claim 2, wherein flowing the return stream into the biological nitrogen removal process comprises flowing a first portion of the return stream into the nitrification process and a second portion of the return stream into the denitrification process to provide at least a portion of alkalinity required during nitrification reactions and at least a portion of hydroxyl required during denitrification reactions.

8. The method of claim 1, wherein the one or more bases comprise caustic, lime, or a combination thereof.

9. The method of claim 1, wherein the return stream comprises carbonate anions for providing alkalinity to the nitrification process.

10. The method of claim 1, wherein the one or more vapor removal devices comprise one or more steam, air, or vacuum strippers or a combination thereof.

11. The method of claim 1, further comprising:
providing hydrothermal processing by separating an influent stream into the waste stream and a primary sludge, the waste stream comprising water effluent; and
anaerobically digesting the primary sludge and dewatering the digested primary sludge to convert the primary sludge to a Class A biosolid without subjecting the primary sludge to a hydrothermal process, and hydrothermally processing the sludge produced during treatment of the waste stream.

12. The method of claim 11, further comprising:
aerobically digesting the water effluent;
separating the digested water effluent to provide a waste activated sludge; and
treating the waste activated sludge using a hydrothermal process.

13. The method of claim 12, wherein:
separating the digested water effluent forms the waste activated sludge and a water effluent return stream, and
the water effluent return stream is flowed into the ammonia recovery process.

14. The method of claim 13, wherein at least a portion of the one or more bases are flowed into the hydrothermal processing.

15. The method of claim 13, further comprising separating the return stream flowing into the biological process into a first return stream and a second return stream, the first return stream having high alkalinity levels and the second return stream having an alkalinity concentration of from approximately 500 parts per million to approximately 20,000 parts per million and biological oxygen demand of from approximately 500 parts per million to approximately 30,000 parts per million.

16. The method of claim 15, wherein flowing the return stream into the biological process comprises flowing the first return stream into the nitrification process and flowing the second return stream into a denitrification process, providing at least a portion of alkalinity required during nitrification reactions and at least a portion of biological oxygen demand required during denitrification reactions.

17. The method of claim 13, wherein conducting the biological process to remove ammonia from the first solids-depleted stream comprises separating a treated discharge stream from a sludge stream, wherein a first portion of the sludge stream is flowed into the hydrothermal processing.

18. The method of claim 17, wherein a second portion of the sludge stream is flowed into the biological process.

19. The method of claim 1, wherein the ammonium containing treated solids-rich stream comprises ammonium and bicarbonate.

20. An apparatus for removing ammonia from a waste stream, comprising:
one or more separating devices for separating an anaerobically digested waste stream into a solids-rich stream and a solids-depleted stream;
an ammonia recovery system for recovering ammonia from the solids-depleted stream, comprising:
a base source for adding one or more bases to the solids-depleted stream, and
one or more vapor removal devices for transforming ammonia in the solids-depleted stream into the vapor phase and subsequently collecting the ammonia in a liquid stream, thereby forming the ammonia liquid stream and a return stream; and
a biological ammonia removal system to remove ammonia from the solids-depleted stream, the biological ammonia removal system comprising a nitrification system, wherein the return stream is flowable through a return pathway from the ammonia recovery system to the biological ammonia removal system.

21. The apparatus of claim 20, the biological ammonia removal system further comprising a denitrification system.

22. The apparatus of claim 20, wherein the one or more vapor removal devices comprise one or more steam, air, or vacuum strippers or a combination thereof.

23. The apparatus of claim 20, wherein the one or more bases comprise caustic, lime, or a combination thereof.

24. The apparatus of claim 20, further comprising one or more aerating devices disposed upstream from the biological ammonia removal system for delivering one or more compressed gases to the waste stream.

25. The apparatus of claim 24, further comprising at least two clarifiers including a first clarifier disposed upstream from the aeration device and a second clarifier disposed downstream from the aeration device.

26. The apparatus of claim 20, further comprising a hydrothermal sludge processing system capable of separating a Class A biosolid from a recycle stream delivered to the ammonia recovery system.

27. A method of removing ammonia from a stream, comprising:
separating a nitrogen containing stream into a first solids-depleted stream and a first solids-rich stream;
treating the first solids-rich stream with a hydrothermal process to produce an ammonium containing treated solids-rich stream;
separating the treated solids-rich stream into a second solids-rich stream and an ammonium containing second solids-depleted stream;
using an ammonia recovery process for removing the ammonia from the second solids-depleted stream, comprising:
adding a sufficient amount of one or more bases to the second solids-depleted stream to convert the ammonium to ammonia and the bicarbonate to carbonate, and
transforming the ammonia into the vapor phase and subsequently collecting the ammonia in a liquid stream using one or more vapor removal devices, thereby separating the liquid ammonia stream from a return stream;
conducting a biological process to remove ammonia from the first solids-depleted stream, the biological process comprising a nitrification process; and
flowing the return stream into the biological process.
